(19) United States
(12) Patent Application Publication
(10) Pub. No.: US 2006/0093720 A1
(43) Pub. Date: May 4, 2006

(54) Pumpable, semi-solid low calorie sugar substitute compositions

(76) Inventor: Ed Tatz, Wayne, NJ (US)

Correspondence Address: FISH & RICHARDSON, PC, P.O. BOX 1022, MINNEAPOLIS, MN, 55440-1022, US

(21) Appl. No.: 11/261,740

(22) Filed: Oct. 27, 2005

Related U.S. Application Data
(60) Provisional application No. 60/623,735, filed on Oct. 28, 2004.

(51) Int. Cl. A23L 1/236

(52) U.S. Cl. 426/548

(57) ABSTRACT

Provided herein are pumpable, semi-solid low calorie sugar substitute compositions, kits and articles of manufacture that include the low calorie sugar substitute compositions, and methods for using the low calorie sugar substitute compositions in comestibles. The low calorie sugar substitute compositions are a semi-solid aqueous gel formed from a polyol; a high intensity sweetener; an insoluble fiber; a gelling agent and an optional thickener.

### RELATED APPLICATIONS

This application claims benefit of priority under 35 U.S.C. §1 19(e) to U.S. Provisional Application Ser. No. 60/623,735, filed Oct. 28, 2004, to Edward Tatz, entitled “PUMPABLE, SEMI-SOLID LOW CALORIE SUGAR SUBSTITUTE COMPOSITIONS,” which is incorporated herein by reference in its entirety.

### TECHNICAL FIELD

Provided herein are low calorie sugar substitute compositions and methods of manufacturing low calorie sugar substitute compositions suitable for use in the preparation of baked goods, frozen desserts, such as ice cream and frozen novelties, and in other prepared solid and semi-solid comestibles.

### BACKGROUND

Obesity is rapidly becoming a major health concern in the United States and other societies in which food is plentiful and readily available in a wide variety of appealing forms. Obesity can be controlled by limiting calorie intake through diet and by exercise to help dissipate calories consumed. Many people are unable or unwilling to subject themselves to dietary limitations and exercise and prefer, instead, to maintain their customary levels of food intake. Some, in doing so, in order to reduce calorie intake, consume products that are formulated to contain fewer calories than their full calorie counterparts. Products of this type are typically referred to using terms such as “low fat, “reduced fat,” “low sugar,” “sugar free,” and “no sugar added” because fat and sugars are the major sources of calories.

The increasing demand for low calorie products has presented a formidable challenge to food manufactures because fat and sugar not only provide energy, they also perform many other functions. Fat, for example, imparts structure, body, mouthfeel and flavor, and acts as a carrier for fat-soluble nutrients and flavors. Sugars also provide structure, body and mouthfeel, and in addition, humectancy, freeze/thaw stability, boiling point elevation, and shelf stability. Thus, fats and sugars that are removed from products in order to reduce calories generally cannot be replaced simply by adding water. Instead, the products have to be completely reformulated, using stabilizers, bodying agents, texturing agents, alternative sweeteners and other food-approved ingredients that collectively are included in an attempt to provide all of the properties that are lost when fats and sugars are removed from a product.

Because of the difficulties associated with the formulation of reduced fat and reduced sugar products, many of the offerings on the market are not entirely satisfactory to the consumer. Attempts to replace fat with protein-based and carbohydrate-based so-called “fat replacers” has been largely unsuccessful. Hence replacement of these fats is a challenge.

Replacement of sugars with high intensity sweeteners now has wide acceptance in beverages. While the creation of these “diet” carbonated beverages has been a major innovation, the primary function of sugar or corn syrup in “regular” beverages is to provide sweetness. Thus, provision of sweetness through the use of high intensity sweeteners in place of more traditional caloric sweeteners has been possible in beverages because other functional properties from these traditional sweeteners are not required. This is not the case in a number of other food products, and reproducing the sweetness provided by traditional caloric sweeteners by replacing the caloric sweeteners with high intensity sweeteners does not provide a satisfactory end product.

Formulation of edible products having a reduced level of calories as a result of removal or partial removal of sugar and other caloric sweeteners such as corn syrup and high fructose corn syrup involves substitution of the sugar or other caloric sweetener with compounds such as polyols, sometimes referred to as sugar alcohols, and water. In addition to providing fewer calories than sugar, polyols also impart some of the other properties provided by sugar and other caloric sweeteners. The amount of polyols that can be added to a product is limited because they can produce a laxative effect. As a result, formulation of reduced sugar products, in addition to replacing sugar with polyols and water, involves addition of other ingredients to the aqueous phase in order to “structure” the water and attempt to provide at least some of the properties lost by sugar removal, such as body, texture, mouthfeel, and shelf stability. Ingredients typically used to structure the aqueous phase are hydrocolloids or gums, starches, and insoluble fillers. Many such ingredients are available and hence specific low calorie, reduced-sugar and no-sugar products, available in the stores under different brand names, can contain distinct and different combinations of ingredients. Significantly, this demonstrates that no single composition exists that can be used as a replacement for sugar or other caloric sweeteners in comestibles.

A need has long existed in the food and pharmaceutical industry for a low calorie sugar substitute sweetener composition that is convenient to use and is storage stable. The preparation of cakes, cookies, ice cream, puddings, and other solid and semi-solid comestibles that have a significantly reduced calorie content and that retain the quality and organoleptic properties of conventional comestibles has been an elusive goal. Caloric sweeteners, such as sugar, corn sweeteners and syrups, and honey, play several roles in comestibles in additional to sweetening, and when they are replaced with low calorie substitutes, more than just sweetness must be provided for by their replacement products. For instance, in addition to sweetness, sugar provides bulk, it reduces the water activity in baked goods by immobilizing water, it acts as a humectant to thereby affect the moisture of the finished product, and it affects the gelatinization temperature of starches during baking, and thereby plays a significant role in the structure, volume, and tenderness of the finished product. In ice cream, sugar provides texture, viscosity, mouthfeel, and freezing point depression. In semi-solid comestibles, sugar contributes to the basic texture and mouthfeel of the product.

High intensity sweeteners can provide the sweetness of sugar, and some blends of high intensity sweeteners can mimic the taste of sugar. High intensity sweeteners by themselves do not provide the other functional attributes of sugar in a food product. In addition, the high intensity sweeteners are many times sweeter than sugar, and thus only a small amount of a high intensity sweetener is needed to achieve the same sweetness equivalency as the sugar. Thus, it is highly desirable to provide a means for uniformly dispersing a high intensity sweetener so as to avoid “hot spots” of high intensity sweetener in a comestible.

Thus, there is a need for a low calorie sugar substitute composition for use in calorie-reduced food products that can duplicate or imitate the appearance, taste, texture, mouthfeel and performance characteristics of existing full-calorie foods, such as those made with sugar or corn sweeteners. Therefore, among the objects herein, it is an object to provide a low calorie sugar substitute composition and methods to produce such compositions.

### SUMMARY

Provided herein are low calorie sugar substitute compositions and methods of manufacture of low calorie sugar substitute compositions. Also provided are processes for making a low calorie sugar substitute composition. These processes accommodate a wide range of compositions in order to suit each particular food application and can produce consistent products.

The low calorie sugar substitute composition is easy to manufacture, versatile and makes possible the preparation of a semi-solid pumpable low calorie sugar substitute composition that can be used as a low calorie replacement system in prepared foods without significantly altering the performance characteristics of such foods. The low calorie sugar substitute composition is suitable for use in solid and semi-solid food applications and satisfactorily fulfills many of the roles of sugar and other caloric sweeteners, providing sweetness and the organoleptic properties and sensory qualities normally imparted by sugar. The low calorie sugar substitute compositions provided herein can be provided in a number of forms that can be engineered by alteration of the ratios of ingredients or elements thereof to meet the performance requirements of any comestible to which they are added.

Also provided is a low calorie sugar substitute composition that is shelf-stable and that can be stored in sealed or re-sealable shipping units for periods of time and later distributed to food processing or manufacturing plants for production of comestible goods. The sealed or re-sealable shipping units can also be sold directly to consumers for home use. The low calorie sugar substitute composition can be packaged in containers, packets, tubs, pails, buckets and barrels as an article of manufacture.

Also provided is a combination of the low calorie sugar substitute composition provided herein and one or more ingredients of a comestible. The combination can be provided for home or commercial use. The combination can include instructions for using the combination, such as, but not limited to, instructions for mixing, cooking (e.g., time, temperature), packaging and serving the resulting comestible.

Also provided are food products that include the low calorie sugar substitute composition provided herein that are easy to manufacture, exhibit superior quality and performance characteristics over existing low-calorie foods, can be made available in a number of consumer- or manufacturer-convenient forms, and which according to alteration of the processing method and the ratios of ingredients or elements employed can be engineered to meet the performance requirements of any foods to which they are intended to be added.

Also provided are food product mixes that include the low calorie sugar substitute composition. Such mixes include, but are not limited to, pre-made refrigerated slice-and-bake cookie doughs, pre-made frozen place-and-bake cookie doughs, packaged mixes for baked goods, including, but not limited to, cakes, muffins, brownies, donuts and pastries, and pre-mixes for frozen desserts, including, but not limited to ice cream mix, ice milk mix and milk shake mix.

Also provided is a low calorie sugar substitute composition with thermal stability in baking and cooking similar to that of sucrose.

Also provided are methods for reducing the caloric content of a comestible. Replacing at least a portion of the caloric sweeteners in a food formulation, such as sugar (for example, cane sugar, beet sugar or maple sugar) or corn sweeteners, with the low calorie sugar substitute composition provided herein allows the formulation of food products in which a significant reduction in calories can be achieved.

Also provided is a process for retarding moisture migration in a baked good by including in the formulation the low calorie sugar substitute composition provided herein.

Also provided is a process for extending the shelf life of a baked good product, which includes adding an anti-staling effective amount of the low calorie sugar substitute composition provided herein.

Also provided is a method of enhancing the flavor of a comestible, which includes adding a flavor enhancing effective amount of the low calorie sugar substitute composition provided herein.

In addition, the use of the low calorie sugar substitute composition provided herein in comestibles results in the food products exhibiting improved qualities, e.g., softer texture, enhanced taste, smoother mouthfeel, etc., relative to traditional food products containing sugar as the sweetener. Thus, also provided are methods for enhancing the organoleptic properties of food products, which includes admixing an organoleptic improving effective amount of the low calorie sugar substitute composition provided herein.

Low calorie sugar substitute compositions provided herein include a combination of water, a polyol, a high intensity sweetener, an insoluble fiber, a gelling agent and optionally a thickener. Also provided are comestibles, such as baked goods, frozen desserts such as ice cream, frozen novelties and water ices, and other solid and semi-solid comestibles prepared using the reduced calorie sugar substitute composition provided herein.

### DETAILED DESCRIPTION

A. Definitions

Unless defined otherwise, all technical and scientific terms used herein have the same meaning as is commonly understood by one of skill in the art to which the invention(s) belong. All patents, patent applications, published applications and publications, databases, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it understood that such identifiers can change and particular information on the internet can come and go, but equivalent information can be found by searching the internet. Reference thereto evidences the availability and public dissemination of such information.

As used herein, synergy or synergistic refers to an interaction of agents (such as sweeteners) or conditions such that the total effect is greater than the sum of the individual effects. When referring to the intensity response of a blend of sweeteners, a synergistic intensity response is one that is greater than the sum of intensities provided by the individual components.

As used herein, the sweetness temporal profile of a compound is its sweetness intensity measured over time. It is a property that can be used to differentiate sweeteners.

As used herein, bakery fillings include, without limitation, low or neutral pH fillings, high, medium or low solids fillings, fruit or milk based (pudding type or mousse type) fillings, hot or cold make-up fillings and non-fat to full-fat fillings.

As used herein, an insoluble fiber refers to materials that are resistant to human digestive enzymes and do not dissolve in water. These can be synthetic or derived from a natural product, such as from a botanical source. An insoluble fiber, when ingested in a monogastric animal, especially a human, reaches the large intestine essentially unchanged. The insoluble fiber can serve as a microbial substrate and can contribute to unfermented and undigested matter of the feces. Components of insoluble fiber from botanical sources can include cellulose, hemi-cellulose and lignin. Insoluble dietary fiber can include morphologically intact cellular tissues of various seed brans, hulls, and other agricultural by-products (Dintzis et al., Cereal Chem. 56:123-127 (1979)) as well as synthetic fibers. Another form of insoluble dietary fiber is microcrystalline cellulose derived from partially acid-hydrolyzed wood (Battista et al., U.S. Pat. No. 2,978,446). Microcrystalline cellulose includes poorly dispersible particles requiring suspending agents to obtain suitable products. The insoluble qualities of the microcrystalline cellulose have been improved by coprocessing the cellulose with gums (McGinley et al., U.S. Pat. No. 5,192,569; Tuason et al., U.S. Pat. No. 5,366,742; and Minami et al., U.S. Pat. No. 5,415,804). Another form of insoluble dietary fiber is bacterial cellulose, derived from any of the strains of Acetobacter that are capable of producing cellulose, such as described in U.S. Pat. Nos. 6,429,002 and 6,110,712.

It can be determined empirically whether an unknown fiber is an insoluble fiber. For example, accepted assays for the determination of non-digestible insoluble fiber are American Association of Cereal Chemists (AACC) Methods 32-05 and 32-07. Briefly, these assays extract lipid, enzymatically digest carbohydrate and protein and arrive at the remaining non-digestible fiber content gravimetrically.

The AACC Method 32-07 (AACC Method 32-07 (1995) “Determination of soluble, insoluble and total dietary fiber in foods and food products,” Approved Methods of the American Association of Cereal Chemists, 9th ed. St. Paul, Minn.: Am. Assoc. Cereal Chem.), which is exemplary of methods for assessing soluble and insoluble products, is performed by first preparing the sample by removing sugars and lipids. For example, sugar in the sample is removed by extraction with 85% ethanol and the sample is then dried under vacuum at 70° C. or lyophilized. Lipids are then removed by solvent extraction, such as by use of hexanes or other lipophilic solvents. The sample is then dried and milled into a powder. The powder is then dispersed into an aqueous buffer and subjected to enzymatic digestion. It is treated with amylase at 95°-100° C. for 15 minutes, protease at 60° C. for 30 minutes, and amyloglucosidase at 60° C. for 30 minutes. The digested sample is then filtered and washed, and the filter cake material is insoluble fiber, corrected for any residual protein and ash. The filtrate is further processed by precipitation with alcohol, and the resulting precipitate is washed and further precipitated with alcohol and then filtered. The weight of the precipitate is the soluble fiber, corrected for protein and ash.

As used herein, a soluble dietary fiber source refers to a fiber source in which at least 60% of the dietary fiber is soluble dietary fiber as determined by AACC Method 32-07, and an insoluble dietary fiber source refers to a fiber source in which at least 60% of the total dietary fiber is insoluble dietary fiber as determined by AACC Method 32-07.

Exemplary insoluble fibers include, but are not limited to, fiber extracted from the bamboo plant, finally ground soy fibers (such as soy hull fiber and soy cotyledon fiber), corn bran fiber, corn fiber, sugar beet fiber, pea hull fiber, wheat bran fiber, wheat plant fiber, oat bran fiber, rice bran fiber, cellulose (alpha cellulose), hemi-cellulose (beta & gamma cellulose), microcrystalline cellulose and bacterial cellulose.

Exemplary soluble fibers include, but are not limited to, agar, alginates, carrageenan, furcellaran, fucoidin, laminarin, guar gum, tara gum, tamarind seed gum, gum arabic, alternan, gum tragacanth, gum ghatti, karaya gum, locust bean gum, inulin, konjac seed flour or konjac mannan, pectin, psyllium, okra gums, tamarind, dextran, polydextran, gellan gum, rhamsan gum, welan gum, xanthan gum, chitosan, scleroglucan, dextrin, methyl cellulose, carboxymethylcellulose, hydroxyalkyl derivatives of cellulose, hydroxypropylcellulose, hydroxyethyl cellulose, methyl hydroxypropyl cellulose, propylene glycol alginate, hydroxyalkylated guar, carboxymethylated guar and modified starches, such as resistant starch and cross-linked starch.

As used herein, algin or alginate is used to describe alginic acid and its various inorganic salt forms, which are derived from brown seaweeds (Phaeophyceae). The monovalent salts, often referred to as alginates, are hydrophilic colloids and these, especially sodium alginate, are widely used in the food industry. Alginate is a linear co-polymer composed of two monomeric units—D-mannuronic acid and L-guluronic acid. These monomers occur in the alginate molecule as regions made up exclusively of one unit or the other, referred to as M-blocks or G-blocks, or as regions in which the monomers approximate an alternating sequence. The calcium reactivity of alginates is a consequence of the particular molecular geometries of each of these regions.

As used herein, comestible refers to any substance that can be used as food. A comestible refers to a substance with food value and includes the raw material or ingredients of a food product before or after processing. The disclosed low calorie sweetener composition is useful for sweetening a large number of comestibles, including, but not limited to, processed flavored dairy drinks, egg nogs, baked goods, dairy desserts, breakfast bars, custards, puddings, salad dressings, sauces, ice creams, sherbets and flavored ices, ice milk products, icings, confections and confection toppings, syrups and flavors, jams and jellies, cake and pastry mixes, pie fillings, sports drinks, nutrition bars, nutrition gels, probiotic yogurt and cultured dairy foods. Other edible formulations that can be sweetened by the compositions provided herein, include, but are not limited to, pharmaceutical and nutraceutical products requiring a sweetener.

As used herein, food additive refers to any substance the intended use of which results or may reasonably be expected to result, directly or indirectly, in its becoming a component or otherwise affecting the characteristics of any food, including any substance intended for use in producing, manufacturing, packing, processing, preparing, treating, packaging, transporting, or holding food. Examples of food additives include components which, by themselves are not additives such as vitamins, minerals, color additives, anti-microbial agents and preservatives, which when added to food are food additives.

As used herein, color additive refers to any food-grade dye, pigment, or other substance that when added or applied to a food is capable of imparting color thereto.

As used herein, the term functional food is a term of art that refers to food designed with functional additives that effectively combine ingredients not usually found together in a single food source. Functional foods have the appearance and structure of conventional foods, but contain significant levels of biologically active components that impart health benefits or desirable physiological effects beyond basic nutrition. An example of a functional food is a food that is not normally high in fiber to which fiber is added. Another example of a functional food is a dairy product with lactase as a food additive, where the lactase combats lactose intolerance.

As used herein, vitamins, minerals and other such supplements generally refer to nutritive food additives that can occur in or be added to a food product.

As used herein, moderate to high solids, when referring to a comestible, is a level of solids in a comestible that is greater than about or at 25% solids.

As used herein, low solids, when referring to a comestible, is a level of solids in a comestible that is less than about or at 24% solids.

As used herein, heat stable refers to the ability of an ingredient to withstand thermal processing (such as, for example, baking, retorting and extrusion) such that it does lose one or more functional properties. For example, when referring to a high intensity sweetener, a heat stable high intensity sweetener retains its ability to sweeten. When referring to a gelled system, a heat stable gel does not melt when thermally processed, such as during baking, retorting and other such processes.

As used herein, to bake or baking refers to subjecting the mixed uncooked ingredients of a baked good to a heat sufficient to transform the ingredient mix into the final baked good. The uncooked ingredients are usually placed in an oven heated to a temperature of about or at 300° F. to about or at 450° F. for a time period of from about or at 5 minutes to about or at 90 minutes. The heat can be dry, or a moist heat can be used, such as by steam injection or by including a pan of water in the oven during the heating process. The exact baking parameters necessary for manufacturing a given food product can be determined empirically.

As used herein, an oven refers to an enclosed compartment, whether portable or fixed, which can be used for cooking. In cooking, the oven is a common kitchen appliance and is used for baking, broiling, roasting and heating food. Food normally cooked in this manner includes meat, casseroles and baked goods. Exemplary ovens include, but are not limited to, microwave ovens, solar ovens, convection ovens, pizza ovens, electric ovens, gas ovens, wood-fired ovens, brick ovens, and commercial ovens such as deck ovens, countertop ovens, conveyor ovens and multi-zone ovens.

As used herein, baked good is a term of art and is understood by the skilled artisan. A baked good generally refers to foods that are cooked in an oven. The baked goods food category (such as defined in 21 CFR 170.3(n)(1), April 2003 edition) includes all baked goods and baking mixes, including all ready-to-eat and ready-to-bake products, flours, and mixes requiring preparation before serving. Baked goods encompass a number of products, which include, but are not limited to, cakes, crackers, cookies, brownies, muffins, rolls, bagels, strudels, pastries, croissants, biscuits, bread, and bread products (e.g. pizza), buns, and fillings and jellies. Baked goods generally include at least some common ingredients. They all contain a sweetener, such as sugar, water and fat. Most also contain flour. Additional ingredients can be added to the baked goods. For example, an additional component found in some baked goods is an oil. The ingredients of a baked good and the amounts thereof vary, depending upon the baked good to be made.

As used herein, dough is a mixture of flour and other ingredients stiff enough to knead or roll.

As used herein, batter is a mixture of ingredients including flour, liquids such as milk or water and other ingredients and is generally thin enough to pour or drop from a spoon.

As used herein, gluten refers to a network of intertwined water insoluble proteins (gliadin and glutenin) with water molecules trapped in between. The fibrous protein strands of glutenin and gliadin have properties of elasticity and plasticity that make raised breads possible. Rye flour contains gluten consisting of only glutenin and not gliadin, making it inferior to wheat gluten for baking. Other grains such as barley and oats have small amounts of gluten.

As used herein, shortening refers to softening the gluten strands with fat. Useful fats for shortening include fats that are solid at room temperature, such as butter and vegetable shortening. “Greasing the gluten” helps to tenderize and assist in preserving the shelf life of baked goods.

As used herein, fat refers to a mixture of triglycerides. These triglycerides are formed from molecules of fatty acids joined to one molecule of glycerol. As used herein fat includes both fats that are solid at room temperature, e.g. butter, margarine, and lard, as well as fats that are liquid at room temperature, usually called oils, (e.g. canola oil, olive oil). The terminology applied to fats is based on the chemical structure of their molecules. Fats differ from oils only in that they are solid at room temperature, while oils are liquid. Solid fats and oils share a common molecular structure, but when used in a recipe, they fulfill different functions. For example, the milk fat in butter is what gives this fat its unique properties. In baked goods, it contributes tenderness, structure, color, flavor and flavor release. Vegetable oil does not act as a shortener because it is a liquid, and oil won't cream with crystalline sugar in the same way as a solid fat. Oil will tenderize a recipe, so it's good in quick-breads, but doesn't contribute much flavor. It reduces dryness and enhances flavor, and has the same number of calories and fat grams as butter, even though it has less saturated fat.

As used herein, the term sweetener includes caloric sweeteners, low calorie sweeteners and non-caloric sweeteners or combination thereof.

As used herein, a caloric sweetener or nutritive sweetener refers to a sweetener that is metabolized in the body to produce energy, such as a sugar, which produces about 4 Kcal/g of energy. Such materials include monosaccharides, disaccharides, polysaccharides and mixtures thereof. Examples include, but are not limited to, xylose, ribose, glucose, lactose, mannose, galactose, fructose, dextrose, sucrose, maltose, fructo-oligosaccharide syrups, partially hydrolyzed starch, corn syrup solids, glucose syrup solids, honey, maple sugar, brown sugar and mixtures thereof.

As used herein, a low calorie sweetener refers to a sweetener that can be partially metabolized in the body to produce energy but that produces less energy than sugar, or less than 4 Kcal/g of energy. Many of the polyols are exemplary of low calorie sweeteners.

As used herein, a non-caloric or non-nutritive sweetener is a molecule or compound that generally provides only sweetening, with only negligible if any energy in the body. This can be because the non-caloric or non-nutritive sweetener is not metabolized by the body, or because such a small amount of the material is used that it contributes little if any calories, and thus substantially less energy than a caloric sweetener providing equivalent sweetening. For example, if a non-caloric sweetener having a relative sweetness of about 200 times that of sucrose is used, the calories contributed by the non-caloric sweetener is about 200 times less than sucrose.

As used herein, sugar refers to sucrose. Sugar can be derived from sugar cane, sugar beet, or from various other botanical sources, such as the sugar maple tree.

As used herein, polyol refers to a group of low-digestible carbohydrates that provide a range of calories per gram—from 0.2 to 3. The approximate average calories per gram is 2, compared to 4 calories per gram from most other sources of carbohydrate. Polyols also are referred to as “sugar alcohols,” although thy are generally designated polyols because they are neither sugar nor alcohol.

As used herein, a humectant refers to a hygroscopic substance that promotes retention of moisture while making water molecules unavailable to starch retrogradation and microorganisms. Two common ingredients with powerful water-binding properties are salt and sugar. Increasing the salt content up to 2% flour weight will increase shelf life without having an adverse effect on flavor. One could also increase the amount of sucrose or use combinations of sugars in order to balance sweetness with humectancy. Caloric sweeteners that have high humectancy values include, but are not limited to, dextrose, glycerol, invert sugar and high fructose corn syrup. Low calorie humectants include, but are not limited to, glycerol, polyols such as sorbitol, xylitol, lactitol, manitol, maltitol, glycerin, glycerol, propylene glycol and mixtures thereof, sugar esters and dextrins.

As used herein, a high intensity sweetener refers to a sweetening agent that has about 30 times to about 13,000 times or more the sweetness of sugar. Suitable high intensity sweeteners include, but are not limited to, dipeptide based sweeteners such as L-aspartyl-L-phenylalanine methyl ester (aspartame) and equivalents (described in U.S. Pat. No. 3,492,131), L-α-aspartyl-N-(2,2,4,4-tetramethyl-3-thietanyl)-D-alaninamide hydrate (alitame) and equivalents; saccharin and its salts, e.g. sodium or calcium saccharin salts; cyclamate and its salts; acesulfame-K; chlorinated derivatives of sucrose such as chlorodeoxysucrose and the like; sucralose, which is the compound 4,1′,6′-trichloro-4,1′,6′-trideoxysucrose; maltol, which is 3-hydroxy-2-methyl-4-pyrone; ethyl maltol; the dihydrochalcones, such as neohesperidine dihydrochalcone; stevia sweeteners such as stevioside and rebaudioside; glycyrrhizin; monoammonium glycyrrhizinate; and protein based sweeteners, such as thaumatin (talin).

As used herein, conventional additives include ingredients that typically can be included in a comestible, and include, but are not limited to such ingredients as leavening agents, flavors, colors, nutrients, anti-oxidants, anti-microbial agents, milk, milk-by products, egg or egg-by-products, cocoa, vanilla, or other flavoring, as well as inclusions, such as nuts, raisins, cherries, apples, apricots, peaches, or other fruits, citrus peel, preservative, coconuts, flavored chips, such as chocolate chips, butterscotch chips, caramel chips and candy pieces. Emulsifiers, which include, but are not limited to, lecithin, surfactants and mono-, di- and triglycerides, can also be present.

As used herein, generally recognized as safe (GRAS) ingredients are food additives that have scientific consensus on their safety based on a history of use prior to 1958 or on well-known scientific information. GRAS substances are listed in the Food Chemical Codex, Fifth Edition (2003). Exemplary GRAS substances regarded as safe for their intended use include common food ingredients such as salt, pepper, vinegar, baking powder, and monosodium glutamate. The Food Chemical Codex provides standards for the purity of food chemicals, promotes uniform quality and ensures safety in the use of such chemicals. The Food Chemicals Codex includes monographs of chemicals that are added directly to foods to achieve a desired technological function as well as specifications for substances that come into contact with foods and some that are regarded as foods, rather than as additives.

As used herein, a leaving agent refers to a substance that causes expansion of doughs and batters by the release of gases within such mixtures, producing baked products with porous structure. Such agents include, but are not limited to, air, steam, yeast, or chemical leavening agents. The chemical leavening agent can include, but are not limited to, baking soda, for example, sodium, potassium, or ammonium bicarbonate, and a baking acid, such as sodium aluminum phosphate, monocalcium phosphate, and dicalcium phosphate or mixtures thereof. Alternatively, for example, a small amount of baking soda can be used alone. Such selection is within the skill of one in the art.

As used herein, cocoa refers to natural or “Dutched” chocolate and can contain from 1% to 30% fatty constituents.

As used here, Dutched chocolate refers to chocolate from which a substantial portion of the fat or cocoa butter has been expressed or removed by solvent extraction, by pressing or by other means. Dutched chocolate is prepared by treating cocoa nibs with an alkali material such as potassium carbonate in a manner well known in the art. Generally, it tends to have a darker flavor and also can be more flavorful than natural cocoas.

As used herein, flavoring agent refers to chemical compounds or molecules such as flavor essences or oils derived from plants, roots, beans, nuts, leaves, flowers, fruits and so forth, equivalent synthetic materials, and mixtures thereof, that are added to flavor a comestible. Flavoring agents are well known in the art. Examples of suitable flavors include, but are not limited to, natural or artificial fruit flavors, such as lemon, orange, banana, grape, lime, apricot, grapefruit, apple, strawberry and cherry, chocolate, pineapple, coffee, vanilla, cocoa, cola, peanut, almond, licorice and cinnamon. The amount of flavoring agent employed is a matter of preference but in general a flavoring agent is used in amounts up to about or at 5%, usually from about or at 0.1% to about or at 1%, by weight of the composition. The flavoring agents can be used alone or in any combination. Some flavoring agents can be used as masking agents to cover or mask undesirable flavor notes or attributes.

As used herein, an anti-microbial agent is a molecule or compound suitable for food use that reduces or prevents microorganism growth in a comestible. See, for example, U.S. Pat. Nos. 3,202,514, 3,202,514 and 3,915,889. Examples of anti-microbial agents include, but are not limited to, sorbic acid and its salts, such as calcium sorbate, sodium sorbate and potassium sorbate, and benzoic acid and its salts, such as calcium benzoate, sodium benzoate and potassium benzoate, natamycin (pimaricin), nisin, and propionic acid and its salts.

As used herein, a combination refers to any association between two or among more items, such as ingredients that comprise a recipe or formulation.

As used herein, organoleptic refers to the effect or impression produced by any substance on the organs of touch, sight, taste, or smell, and also on the organism as a whole. Organoleptic evaluations of food products are subjective, sensory judgments based on the experience of the evaluator. They can involve observing, feeling, chewing and tasting of the products to judge product appearance, color, integrity, texture and flavors. The value in these judgments depends on the experience of the evaluator with the specific products in question. This experience is obtained in handling specific food items in a variety of conditions and with repetitive reinforcements over time. Specific product experience is necessary because sensory attributes for a given comestible can vary from product to product.

As used herein, frozen dessert refers to a wide variety of frozen confections including, but not limited to, ice cream, frozen yogurt, frozen custard, ice milk, sherbet, frozen novelties, frozen dairy confections and frozen non-dairy desserts such as frozen water ices.

As used herein, overrun is a measure of the ability of a whipped dessert product to increase in volume during the whipping or mixing process. For example, a product that doubles in volume (i.e. one gallon to two gallons) is said to achieve 100% overrun. Conventional ice cream products can achieve a batch freezer overrun in excess of 100% and some can achieve an overrun in excess of 150%.

As used herein, rheology refers to a study of the change in form and flow of matter under the influence of stresses, embracing elasticity, viscosity, and plasticity. For example, when liquids are subjected to stress they will deform irreversibly and flow. The measurement of this flow is the measurement of viscosity.

As used herein, shear rate refers to shearing forces experienced by a liquid experiences. A unit of measure thereof is a “reciprocal second” (sec⁻¹).

As used herein, shear stress refers to the force per unit area required to produce the shearing action. A unit of measurement therefore is “dynes per square centimeter” (dynes/cm²).

As used herein, viscosity refers to the tendency of a fluid to resist flow and is defined as shear stress divided by shear strain. A fundamental unit of viscosity measurement is the “poise.” A material requiring a shear stress of one dyne per square centimeter to produce a shear rate of one reciprocal second has a viscosity of one poise, or 100 centipoise. Viscosity measurements can be expressed in “Pascal-seconds” (Pa·s) or “milli-Pascal-seconds” (mPa·s), which are units of the International System and are sometimes used in preference to the Metric designations. One Pascal-second is equal to ten poise; one milli-Pascal-second is equal to one centipoise. Conditions used to measure the viscosity should be provided since non-ideal liquids have different values of viscosity for different test conditions of shear rate, shear stress and temperature.

As used herein, a Newtonian fluid or a fluid that has a Newtonian flow is a fluid whose viscosity is independent of the shear on the fluid. Examples of Newtonian liquids are mineral oil, water and molasses.

As used herein, a pseudoplastic fluid is a liquid having a viscosity that changes with the shear it encounters, and specifically for a fluid where increasing shear rate results in a gradual decreasing shear stress, or a thinning of viscosity with increasing shear.

As used herein, a viscoplastic fluid is a fluid characterized as a non-Newtonian fluid where a yield point must be reached before flow begins. The fluid then exhibits pseudoplastic behavior—decreasing viscosity with increasing shear. Examples of viscoplastic fluids include, but are not limited to, mayonnaise, shortening and margarine.

As used herein, yield point is the amount of stress that must be applied to a plastic or viscoplastic system before flow occurs.

B. Low Calorie Sugar Substitute Compositions

Provided herein are aqueous gel low calorie sugar substitute compositions with multi-functionality. The multi-functionality of the low calorie sugar substitute composition provided herein is manifested its ability to, among other properties, simultaneously provide (a) substantial sweetening for the food product, (b) hygroscopicity or humectancy for the food product, (c) desirable mouthfeel and organoleptic properties for the food product, (d) improved shelf life, particularly for baked goods because of the control of water, and (e) metabolic benefits by increasing the dietary fiber content of a comestible. The low calorie sugar substitute composition provided herein is an aqueous gel that includes a polyol, a high intensity sweetener, an insoluble fiber and a gelling agent. The low calorie sugar substitute composition optionally also includes a thickener.

For example, the reduced calorie sugar substitute composition is an aqueous gel that includes 20%, 25%, 30%, 35%, 40%, 45%, 50%, 55%, 60%, 65% or 70% polyol, a high intensity sweetener, an insoluble fiber, a gelling agent and optionally a thickener.

In another embodiment, the reduced calorie sugar substitute composition is an aqueous gel that includes a polyol, 0.001%, 0.002%, 0.003%, 0.004%, 0.005%, 0.006%, 0.007%, 0.008%, 0.009%, 0.010%, 0.015%, 0.020%, 0.025, 0.030%, 0.035%, 0.040%, 0.045%, 0.050%, 0.055%, 0.060%, 0.065%, 0.070%, 0.075%, 0.080%, 0.085%, 0.090%, 0.095% or 0.1% high intensity sweetener, an insoluble fiber, a gelling agent and optionally a thickener. In another embodiment, the reduced calorie sugar substitute composition is an aqueous gel that includes a polyol, a high intensity sweetener, 0.1%, 0.2%, 0.3%, 0.4%, 0.5%, 0.6%, 0.7%, 0.8%, 0.9%, 1%, 1.5%, 2%, 2.5%, 3%, 3.5%, 40%, 4.5%, 5%, 5.5%, 6%, 6.5%, 7%, 7.5%, 8%, 8.5%, 9%, 9.5% or 10% insoluble fiber, a gelling agent and optionally a thickener. In another embodiment, the reduced calorie sugar substitute composition is an aqueous gel that includes a polyol, a high intensity sweetener, an insoluble fiber and 0.2%, 0.225%, 0.25%, 0.275%, 0.3%, 0.325%, 0.35%, 0.375%, 0.4%, 0.425%, 0.45%, 0.475%, 0.5%, 0.525%, 0.55%, 0.575%, 0.6%, 0.625%, 0.65%, 0.675%, 0.7%, 0.725%, 0.75%, 0.775%, 0.8%, 0.825%, 0.85%, 0.875%, 0.9%, 0.925%, 0.95%, 0.975%, 1%, 1.1%. 1.125%, 1.225%, 1.25%, 1.275%, 1.3%, 1.325%, 1.35%, 1.375%, 1.4%, 1.425%, 1.45%, 1.475%, 1.5%, 1.525%, 1.55%, 1.575%, 1.6%, 1.625%, 1.65%, 1.675%, 1.7%, 1.725%, 1.75%, 1.775%, 1.8%, 1.825%, 1.85%, 1.875%, 1.9%, 1.925%, 1.95%, 01.975% or 2% gelling agent and optionally a thickener. In another embodiment, the reduced calorie sugar substitute composition is an aqueous gel that includes a polyol, a high intensity sweetener, an insoluble fiber, a gelling agent and 0.2%, 0.225%, 0.25%, 0.275%, 0.3%, 0.325%, 0.35%, 0.375%, 0.4%, 0.425%, 0.45%, 0.475%, 0.5%, 0.525%, 0.55%, 0.575%, 0.6%, 0.625%, 0.65%, 0.675%, 0.7%, 0.725%, 0.75%, 0.775%, 0.8%, 0.825%, 0.85%, 0.875%, 0.9%, 0.925%, 0.95%, 0.975%, 1%, 1.1%. 1.125%, 1.225%, 1.25%, 1.275%, 1.3%, 1.325%, 1.35%, 1.375%, 1.4%, 1.425%, 1.45%, 1.475%, 1.5%, 1.525%, 1.55%, 1.575%, 1.6%, 1.625%, 1.65%, 1.675%, 1.7%, 1.725%, 1.75%, 1.775%, 1.8%, 1.825%, 1.85%, 1.875%, 1.9%, 1.925%, 1.95%, 01.975% or 2% thickener. One skilled in the art can select any combination of water, polyol or polyol blend, high intensity sweetener or high intensity sweetener blend, insoluble fiber or insoluble fiber blend, gelling agent or gelling agent blend, and optionally a thickener or thickener blend in a combination of ratios as disclosed above to provide a total aqueous gel composition of 100% that can be used as a low calorie sugar substitute composition.

For example, in one embodiment the reduced calorie sugar substitute composition is an aqueous gel that includes 20-70% polyol, 0.001-0.1% high intensity sweetener, 0.1-10% insoluble fiber and 0.2-2% gelling agent. In other embodiment the reduced calorie sugar substitute composition is an aqueous gel that includes 20-70% polyol, 0.001-0.1% high intensity sweetener, 0.2-2% thickener, 0.1-10% insoluble fiber and 0.2-2% gelling agent. In another embodiment, the low calorie sugar substitute composition is an aqueous gel that includes 30-80% water, 20-70% polyol, 0.001-0.1% high intensity sweetener, 0.1-10% insoluble fiber and 0.2-2% gelling agent. In another embodiment, the low calorie sugar substitute is an aqueous gel that includes 30-80% water, 20-70% polyol, 0.001-0.1% high intensity sweetener, 0.2-2% thickener, 0.1-10% insoluble fiber and 0.2-2% gelling agent.

1. Polyol

Polyols, or “sugar alcohols” as they are sometimes referred, are not technically considered artificial sweeteners, but they are slightly lower in calories than sugar and do not promote tooth decay or cause a sudden increase in blood glucose. Thus, they are often used as low calorie sweeteners. Table 1 below shows a few of the polyols commonly used in comestibles along with their approximate sweetness compared to sucrose and their calories per gram. The relative sweetness value fluctuates because sweetness varies depending on the product in which the polyol is used. Manufacturers frequently use polyols in combination, as well as with other sweeteners to attain the appropriate taste, sweetness temporal profile and sweetness level. The selection of the polyol or polyol blend and the usage level thereof in a given comestible is within the skill of one skilled in the art and can be determined empirically.

TABLE 1
Typical Polyols Used in Comestibles

| | Relative Sweetness | |
|---|---|---|
| Polyol | (Sucrose = 100) | Calories per gram |
| Erythritol | 60-80 | 0.2 |
| Manitol | 50-70 | 1.6 |
| Lactitol | 30-40 | 2.0 |
| Isomalt | 45-65 | 2.0 |
| Maltitol | 70-75 | 2.1 |
| Xylitol | 90-100 | 2.4 |
| Sorbitol | 50-70 | 2.6 |
| Hydrogenated starch | 25-50 | 3 |
| hydrolysates | | |
| Glycerol | 75-80 | 4.3 |

Polyols can be classified by chemical structure as monosaccharide-derived (e.g., sorbitol, mannitol, xylitol, erythritol), disaccharide-derived (e.g., isomalt, lactitol, maltitol), or polysaccharide-derived mixtures (e.g., maltitol syrup, hydrogenated starch hydrolysates [HSH]). Isomalt is a mixture of two disaccharide alcohols (glucomannitol and glucosorbitol). The FDA classifies some of these sweeteners as “generally recognized as safe” (GRAS) and others have been approved by the FDA through the regular approval process for food additives (Position of the American Dietetic Association: Nutritive and nonnutritive sweeteners, Journal of the American Dietetic Association (2004) 104:256).

The calorie contribution from polyols ranges from about or at 0.2 to about or up to and including 3 calories per gram compared to 4 calories per gram for sucrose or other caloric sugars. Most are approximately half as sweet as sucrose; xylitol is about as sweet as sucrose. Polyols provide fewer calories per gram than other carbohydrates because they are slowly and incompletely absorbed from the small intestine. The portion of polyols that is absorbed is metabolized by processes that require a minimal amount or no insulin. The portion that is not absorbed into the blood is broken down into smaller segments in the large intestine or excreted. Due to the incomplete absorption, a large amount of polyols consumed at one time may cause gastrointestinal effects, such as gas or laxative effects similar to reactions to beans and certain high-fiber foods. The severity of the symptoms depends on the individual, amount of the food that is consumed at one time, type of polyol, and existence of any prior period of adaptation. Gastrointestinal symptoms, if they occur, are usually mild and transient. Most people will adapt to the mild gastrointestinal effects within a few days, just as they adapt over time to the initiation of a high-fiber diet.

The low calorie sugar substitute compositions provided herein allow the food manufacturer to reduce the calories per serving using low levels of polyols that generally do not exhibit any gastrointestinal effects. For example, replacing 100 grams of sugar used to sweeten a comestible with 50 grams of a low calorie sugar substitute composition provided herein that contains 35% sorbitol results in a reduction of calories from 400 Kcal/g to about 45.5 Kcal/g, or by around 90%. Thus, the low calorie sugar substitute compositions provided herein not only provide a significant reduction in calorie intake but also limit the amount of polyol consumed, thereby substantially reducing or eliminating any potential laxative effect caused by them.

A wide range of polyols can be used, alone or in combination, in the low calorie sugar substitute compositions provided herein. These include, but are not limited to, erythritol, mannitol, lactitol, isomalt, maltitol, xylitol, sorbitol, glucomannitol, glucosorbitol, glycerol, hydrogenated starch hydrolysates and combinations thereof. For example, in one embodiment, the polyol is selected from among erythritol, mannitol, lactitol, isomalt, maltitol, xylitol, sorbitol and glycerol. In another embodiment, the polyol is sorbitol, glycerol or erthyritol. For highest sweetness equivalency, the polyol selected can be xylitol. For lowest caloric contribution to the composition, the polyol selected can be erythritol. In other embodiments, the polyol is sorbitol.

The combination of some polyols with high intensity sweeteners is synergistic, where the intensity response of the blend is greater than the sum of intensities provided by the individual components. For example, sweetness synergy occurs when erythritol is used in combination with aspartame or with acesulfame-K or blends thereof at various ratios. Further, unlike most high intensity sweeteners, the sweetness temporal profile of polyols in general is similar to that of sucrose. For example, erythritol provides a quick sweetness perception and a short sweet linger. The combination of polyols with high intensity sweeteners also results in the modification of the sweetness temporal profile of the high intensity sweeteners to more closely resemble that of sucrose.

2. High Intensity Sweetener

High intensity sweeteners are known to the skilled artisan, and generally include those compounds that have a relative sweetness of about 30 times to about 13,000 times or more the sweetness of sucrose. Many high intensity sweeteners are about 100 times as sweet at sucrose (see, e.g., Nabors, “Sweet Choices: Sugar Replacements for Foods and Beverages,” Food Technology 56(7): 28-34, 45 (2002)). There are a number of high intensity sweeteners in the world market today, including saccharin, cyclamate, aspartame, acesulfame-K, stevioside, alitame, neotame and sucralose and others awaiting approval for commercial use. Each country has a different subset of these sweeteners that have been approved for food use.

Suitable high intensity sweeteners for use in the compositions provided herein include any sweetener that has a relative sweetness greater than the sweetness of sucrose, particularly at least about or at 30 times more sweet than sucrose. In some embodiments, a high intensity sweetener having a relative sweetness greater than about or at 100 times that of sucrose is selected. In other embodiments, a high intensity sweetener having a relative sweetness greater than about or at 200 times that of sucrose is selected. In other embodiments, a high intensity sweetener having a relative sweetness greater than about or at 250, 300, 350, 400, 450, 500, 550, 600, 650, 700, 750, 800, 850, 900, 950, 1000, 1050, 1100, 1150, 1200, 1250, 1300, 1400, 1500, 1600, 1700, 1800, 1900, 2000, 2250, 2500, 2750, 3000, 3500, 4000, 4500, 5000, 5500, 6000, 6500, 7000,7500, 8000, 8500, 9000, 9500, 10000, 10500, 11000, 11500, 12000, 12500 or 13000 times that of sucrose is selected.

For example, any high intensity sweetener, alone or in combination, can be used in the low calorie sugar substitute compositions provided herein. Exemplary sweeteners include, but are not limited to, saccharin, cyclamate, aspartame, acesulfame-K, stevioside, alitame, neotame, sucralose, the dihydrochalcones (such as neohesperidine dihydrochalcone), thaumatin, glycyrrhizin, monoammonium glycyrrhizinate, stevioside, rebaudioside, maltol, ethyl maltol, chlorodeoxysucrose; sucaril; synthetic alkoxy aromatics, such as dulcin and 5-nitro-2-n-propoxyaniline (P-4000); suosan; miraculin; monellin; substituted imidazolines; synthetic sulfamic acids; n-substituted sulfamic acids; oximes such as perilartine; rebaudioside; peptides such as aspartyl malonates and succanilic acids; amino acid based sweeteners such as gem-diaminoalkanes; meta-aminobenzoic acid; L-aminodicarboxylic acid alkanes; amides of certain α-aminodicarboxylic acids and gem-diamines; and 3-hydroxy-4-alkyloxyphenyl aliphatic carboxylates or heterocyclic aromatic carboxylates.

In one embodiment, the high intensity sweetener is selected from among saccharin, cyclamate, aspartame, acesulfame-K, stevioside, rebaudioside, alitame, neotame, sucralose, neohesperidine dihydrochalcone, monoammonium glycyrrhizinate and thaumatin. In another embodiment, the high intensity sweetener is selected from among acesulfame-K, alitame, neotame and sucralose. In another embodiment, the high intensity sweetener is acesulfame-K. In another embodiment, the high intensity sweetener is alitame. In another embodiment, the high intensity sweetener is neotame. In another embodiment, the high intensity sweetener is sucralose. In another embodiment, the high intensity sweetener is aspartame. In another embodiment, the high intensity sweetener is monoammonium glycyrrhizinate. In another embodiment, a blend of two or more high intensity sweeteners is used. For example, a blend of two or more high intensity sweeteners can include two or more high intensity sweeteners selected from among saccharin, cyclamate, aspartame, acesulfame-K, stevioside, alitame, neotame, sucralose, neohesperidine dihydrochalcone, thaumatin, glycyrrhizin, stevioside, maltol, ethyl maltol, and chlorodeoxysucrose. In one embodiment, a blend including neotame and one or more high intensity sweeteners selected from among saccharin, cyclamate, aspartame, acesulfame-K, stevioside, alitame, sucralose, neohesperidine dihydrochalcone, thaumatin, glycyrrhizin, stevioside, maltol, ethyl maltol, and chlorodeoxysucrose is selected. In another embodiment, a blend including neotame and sucralose is selected. In another embodiment, a blend including neotame and aspartame is selected. In another embodiment, a blend including neotame and alitame is selected. In another embodiment, a blend including neotame, sucralose and alitame is selected. When the composition provided herein is to be used in baked products and other products subjected to heat during manufacture or preparation for consumption, a heat stable high intensity sweetener can be selected. In such embodiments, the high intensity sweetener can be, but is not limited to, neotame, or alitame, or acesulfame-K or sucralose, alone or in any combination. Any combination of temperature stable high intensity sweeteners including two or more temperature stable high intensity sweeteners can be used in the composition provided herein.

Selection of high intensity sweeteners is a finction of a variety of factors and can be arbitrary. For example, exemplary factors that can be considered when selecting a particular high intensity sweetener or blend of sweeteners include, but are not limited to, cost, quality of flavor, flavor profile, sweetness temporal profile, process stability, stability in the comestible and consumer perception of safety of the sweetener. A number of the attributes for some of the exemplary high intensity sweeteners that can be used in the low calorie sugar substitute composition provided herein are provided below. The selection of the high intensity sweetener or blends thereof can be determined empirically for a given comestible. Exemplary sweeteners for use in the compositions provided herein include, but are not limited to, the following.

a. Sucralose

Sucralose is the compound 4,1′,6′-trichloro-4,1′,6′-trideoxysucrose monohydrate (or 1,6-dichloro-1,6-dideoxy-β-D-fructofuranosyl-4-chloro-4-deoxy-α-D-galacto-pyranoside). Sucralose is derived from sucrose and was approved by the FDA in 1998. Sucralose is made from sucrose by selectively replacing three hydrogen-oxygen groups with three chlorine atoms. Sucralose is about 400 to about 800 times as sweet as sucrose. It is sold under the brand name Splenda® (McNeil Labs). Sucralose is heat stable and performs well in recipes that require thermal processing (baking, retorting, extrusion, etc.). Sucralose also has high quality sensory attributes, possessing a clean, quickly perceptible sweet taste. Sucralose is biologically and chemically stable in the dry state and in aqueous solutions. Sucralose has found wide approval in “natural” markets.

b. Acesulfame potassium (acesulfame-K)

Acesulfame potassium is the compound 6-methyl-3,4-dihydro-1,2,3-oxathiazin-4-one 2,2-dioxide potassium salt. It is about 200 to 300 times sweeter than sucrose. Acesulfame K has a clean, quickly perceptible, sweet taste that does not linger and leaves only a slight aftertaste. Acesulfame K is not metabolized by the body and is excreted unchanged. It is sold under the brand name Sunett™ (Hoechst/Celenese). Acesulfame K is used in food products in about 90 countries. In the United States, acesulfame K was granted general purpose approval in December, 2003. Acesulfame K is heat stable and its perceived sweetness remains unchanged during baking. Decomposition is only found at temperatures well over 200° C. Acesulfame K also has a high degree of stability over a wide range of pH and temperature storage conditions. It blends well with other sweeteners and is especially synergistic with aspartame and cyclamate but less so with saccharin. A slight aftertaste may be detected in certain products sweetened with acesulfame-K at high concentrations. Blending with other sweeteners can improve the taste profiles, in addition to offering economic and stability advantages.

c. Aspartame

Aspartame is the dipeptide L-aspartyl-L-phenylalanine-methyl ester. It is approximately 130 to 220 times the sweetness of sucrose. It was approved in the U.S. in 1996 as a general-purpose sweetener. The taste profile of aspartame closely resembles that of sucrose and can enhance food flavors (particularly fruit flavors). Aspartame is stable in its dry state. Aspartame does decompose under combinations of high temperature, high pH and high moisture, resulting in loss of sweetness. Aspartame can withstand high-temperature, short time and ultra-high-temperature pasteurization temperatures used for dairy products and aseptic processing. It is generally benefited from blending with acesulfame-K or saccharin for stability.

d. Neotame

Neotame is structurally similar to aspartame and is the compound N-[N-(3,3-dimethylbutyl)-L-aspartyl]-L-phenylalanine 1-methyl ester. Neotame is a heat-stable sweetener produced by the hydrogenation of aspartame and 3,3-dimethylbutyraldehyde. Neotame is 30 to 60 times sweeter than its aspartame precursor and thus about 7,000 to 13,000 times sweeter than sucrose. Neotame was approved by FDA in July 2002. Neotame has a clean sweet taste that has a sweetening profile similar to sucrose. For example, its onset and linger closely match sucrose in many aqueous applications. It also enhances and extends flavor in prepared foods. Neotame is subject to degradation in the presence of moisture and the rate of degradation is pH-, temperature- and time-dependent. It does overcome some of aspartame's stability shortcomings in baked goods, fermented products like yogurts, and certain flavoring systems. Neotame functions as a flavor enhancer in some applications and certain flavor systems and can be used to extended sweetness perception of other sweeteners. Neotame also provides flavor masking properties in comestibles and thus can be used to mask off-flavors or to create unique taste profiles.

e. Alitame

Alitame is a sweetener similar to aspartame in structure. Alitame is composed of amino acids, including L-aspartic acid, D-alanine and 2,2,4,4-tetramethylthietanyl amine. It is about 12 times sweeter than aspartame, or about 2,000 times sweeter than sucrose and does not have the bitter or metallic qualities of some high-intensity sweeteners. It is sold under the brand name Aclame™ (Pfizer, Inc.). Alitame has a clean, sweet taste that closely resembles sugar. Alitame is substantially more stable than aspartame at elevated temperatures and over a broad pH range. It is highly soluble in water and has a synergistic sweetening effect when combined with some other low-calorie sweeteners, such as acesulfame K, cyclamate and aspartame.

f. Saccharin

Saccharin is the compound o-benzoic sulfimide (1,1-diox-1,2-benzisothiazol-3-one or 3-benzisothiazolinone 1,1-dioxide). Saccharin exceeds the sweetness of sugar by about 200 to 700 times. It provides no energy because it is not metabolized by humans. The FDA has approved saccharin (in the ammonium saccharin, calcium saccharin, and sodium saccharin forms) as a sweetener in various comestibles. Saccharin often produces a bitter metallic aftertaste in some comestibles, which can be reduced or eliminated by combining saccharin with other high intensity sweeteners, such as aspartame and cyclamates. Another approach to limit saccharin's aftertaste is the use of “masking agents.” For example, a blend of cream of tartar with a small amount of dextrose can be used as a masking agent with saccharin. Also, the calcium salt of saccharin possesses a shorter, cleaner aftertaste with less bitterness than sodium saccharin. The perceived sweetness and taste profile of saccharin can be adjusted using blends with other sweeteners. For example, binary mixtures of saccharin and aspartame, cyclamate, sucralose and alitame have synergistic effects, while binary mixtures of saccharin and acesulfame-K have additive effects.

g. Cyclamate

Cyclamate is the calcium or sodium salt of cyclamic acid (or cyclohexanesulfamic acid) and the predominate cyclamates are calcium cyclohexylsulfamate and sodium cyclohexylsulfamate. Sodium and calcium cyclamate are about 30 to 50 times sweeter than sucrose, and sweetness depends on concentration since it is not a linear relationship. Cyclanates are the least utilized of the commercially used high intensity sweeteners. Cyclamate is often used synergistically with other artificial sweeteners such as saccharin (such as 10 parts cyclamate to 1 part saccharin) but it is synergistic with a wide array of sweeteners and polyols. It is less expensive than most sweeteners, including sucrose, and is stable under heating.

h. Neohesperidine DHC—a dihydrochalcone

The dihydrochalcones are non-caloric sweeteners derived from bioflavonoids of citrus fruits. The dihydrochalcones are approximately 300 to 2,000 times sweeter than sucrose. Neohesperidine dihydrochalcone, synthesized from Seville oranges, is about 1,500 times sweeter than sucrose. The dihydrochalcones have a delayed sweet taste and by themselves have a licorice aftertaste. Neohesperidine DHC offers foods and beverages a licorice flavor and can enhance the mouth-feel of beverages. In the United States, neohesperidine dihydrochalcone is GRAS as a flavor ingredient but not as a sweetener. EU countries have authorized the use of this sweetener in a range of energy-controlled products.

i. Stevia

p Stevia generally refers to the diterpenoid glycosides extracted from a South American shrub Stevia rebaudiana bertoni (see Zhang et al., “Stevia rebaudiana leaves: A Low Calorie Source of Sweeteners,” Canadian Chemical News, May 1999). Stevia has about 250 to 300 times the sweetness of sucrose and is often used as a flavor enhancer. Stevia derives its sweetness from the presence of stevioside and rebaudiosides. Rebaudioside A is considered to have a taste profile superior to that of stevioside. Stevia has a sweet taste similar to cane sugar with a slightly bitter aftertaste. Stevia is heat stable to 200° C. and stable in acid solutions and in the presence of salt. Stevia is approved for use in 10 countries, including Japan, Paraguay and Brazil. Stevia is sold as a “dietary supplement” in the U.S. but is not yet approved as a non-nutritive sweetener.

j. Thaumatin

Thaumatin is a mixture of proteins isolated from the katemfe fruit of west Africa (Thaumatococcus daniellii Benth). There may be several related proteins in the plant; two main forms, thaumatin I and thaumatin II, are known. Thaumatin is very sweet-tasting, with a slow onset, lingering sweetness and a licorice after-taste. Thaumatin is about 2,000 to 2,500 times sweeter than sucrose on a weight basis. Thaumatin also acts as a flavor modifier, enhancing sweet and savory flavors. In the United States, thaumatin is GRAS as a flavor adjunct for a number of categories. Thaumatin acts synergistically with saccharin, acesulfame K and stevioside. Thaumatin is not heat stable and cannot be used in comestibles that are heated during processing.

k. Glycyrrhizin

Glycyrrhizin is a triterpene glycoside with the systematic name (3-β,20-β)-20-carboxy-11-oxo-30-norolean-12-en-3-yl-2-O-β-D-glucopyranuronosyl-α-D-glucopyranosiduronic acid. Glycyrrhizin is the active principle of licorice root, and has been used for numerous medical purposes, particularly treatment of peptic ulcer, and as an expectorant. Glycyrrhizin is about 50 to 100 times sweeter than sucrose, and also has a strong licorice note. Glycyrrhizin is often used as a flavor modifier because of its ability to mask bitterness. For example, the addition of glycyrrhizin to an alcoholic extract of coffee eliminates the coffee's bitter taste. Monoammonium glycyrrhizinate (MAG) is a derivative of glycyrrhizin and the extraction/purification process used for its production removes the residual licorice taste, leaving a sweetener that is intensely sweet but otherwise unflavored. Glycyrrhizin potentiates sweetness, masks chemical off-notes, reduces harsh and bitter notes, and enhances other flavors.

3. Thickener

An optional element or ingredient of the disclosed low calorie sugar substitute composition is a thickener. The thickener is an accessory structurant, and can be used to contribute to the viscosity of the composition as well as to provide additional functionality, such as additional moisture retention. Examples of polymers that can be used as a thickener are the various polysaccharides or gums that can be characterized from their source or origin. For example, the polysaccharide can come from a marine plant, a terrestrial plant, or a microbial source. The polymer also can be a synthetic polysaccharide derivative. The polymer can also be derived from animal sources (e.g., from skin and/or bone of animals) such as gelatin.

Examples of polymers from marine plants include, but are not limited to, the polysaccharides agar, alginates, carrageenan, fucoidin, furcellaran and laminarin. Examples of polymers from terrestrial plants include, but are not limited to, guar gum, tara gum, tamarind seed gum, gum arabic, alternan, gum tragacanth, karaya gum, gum ghatti, psyllium, tamarind, locust bean gum, inulin, konjac seed flour or konjac mannan and pectin. Examples of polymers from microbial sources include, but are not limited to, the polysaccharides dextran, gellan gum, rhamsan gum, welan gum and xanthan gum. Examples of polymers that are synthetic polysaccharide derivatives include, but are not limited to, carboxymethylcellulose, methyl hydroxypropyl cellulose, hydroxypropyl cellulose, hydroxyethyl cellulose, propylene glycol alginate, hydroxypropyl guar and modified starches.

Exemplary thickening polymers for use in the composition provided herein include, but are not limited to, xanthan gum, guar gum, tara gum, gum arabic, alternan, konjac mannan, inulin, gum tragacanth and cellulose derivatives. In one embodiment, the thickener is a polymer that is cold water soluble. For example, guar gum, xanthan gum, and the cellulose derivatives are cold water soluble. Guar gum is a low cost cold water soluble polymer that is highly efficient, requiring low concentrations in order to provide additional viscosity. In one embodiment, the thickener is selected from among xanthan gum, guar gum, tara gum, inulin, gum tragacanth, carboxymethylcellulose, methyl hydroxypropyl cellulose, hydroxypropyl cellulose, hydroxyethyl cellulose, propylene glycol alginate, hydroxypropyl guar and modified starches. In another embodiment, the thickener is selected from among guar gum, tara gum, inulin and carboxymethyl cellulose. In another embodiment, the thickener is guar gum. In another embodiment, the thickener is tara gum.

4. Insoluble Fiber

Dietary fiber is the edible parts of plants or analogous carbohydrates, or any synthetic fibers, that are resistant to digestion and absorption in the human small intestine, and can be completely or partially fermented in the large intestine, or can pass through the large intestine unchanged. Dietary fiber includes polysaccharides, oligosaccharides, lignin, and associated plant substances as well as synthetic fibers. Dietary fibers promote beneficial physiological effects including laxation, and/or blood cholesterol attenuation, and/or blood glucose attenuation.

It is desirable to increase the intake of dietary fiber. Recommended intake of dietary fiber is 25 grams per day for females and 38 grams per day for males. The median intakes of fiber for each gender have been steadily declining to where they are about half of the recommended intakes. Thus, providing increased dietary fiber in comestibles is desirable. Increasing the fiber content of foods, particularly snack foods and baked goods, has traditionally not been very popular, or very easy.

Dietary fiber, especially insoluble fiber, may negatively impact the organoleptic properties of a comestible. For example, increased levels of soluble fiber may give the impression of a slimy or gummy mouthfeel. An increased level of insoluble fiber often imparts a gritty texture to a comestible. One solution to the gritty texture that insoluble fibers often contribute to food products has been to grind the fibers to produce finer powders. Fibers from agricultural byproducts also can be treated with alkaline or alkaline/peroxide (see, e.g., Gould, U.S. Pat. Nos. 4,649,113 and 4,806,475), Gould et al. (U.S. Pat. No. 4,774,098), Ramaswamy (U.S. Pat. No. 5,023,103); and Antrim, (U.S. Pat. No. 4,038,481). Other methods are known for improving the organoleptic properties of fiber. For example, the morphological cellular structures of corn bran, wheat bran, oat hulls, pea hulls, soybean hulls and rice can be substantially disintegrated to produce insoluble fiber (see, e.g., U.S. Pat. No. 5,766,662).

The low calorie sugar substitute compositions provided herein include dietary fiber and thus allow the production of comestibles that are low in net carbohydrates and higher in dietary fiber while retaining the organoleptic properties of the comestibles. Addition of the low calorie sugar substitute composition provided herein to a formulation or comestible does not impart a gummy or gritty texture. Thus, addition of the low calorie sugar substitute composition provided herein to a comestible allows the addition of dietary fiber to the diet while maintaining the positive sensory and organoleptic attributes of the comestible.

Examples of insoluble fiber for inclusion in compositions provided herein include, but are not limited to, fiber extracted from the bamboo plant, (for example, CreaFibe® QC, which is about 98.5% insoluble fiber with less than 0.2 calories per gram), finally ground soy fibers (such as soy hull fiber and soy cotyledon fiber), corn bran fiber, corn silk fiber, corn plant fiber, sugar beet fiber, pea hull fiber, wheat bran fiber, wheat plant fiber, oat bran fiber, rice bran fiber, cellulose (alpha cellulose), hemicellulose (beta & gamma cellulose), microcrystalline cellulose, bacterial cellulose and chicory root fiber. In one embodiment, the insoluble fiber is selected from among soy fiber, corn bran fiber, corn fiber, wheat bran fiber, wheat plant fiber, oat bran fiber, rice bran fiber, pea hull fiber and cellulose and combinations thereof. In another embodiment, the insoluble fiber is wheat plant fiber. In another embodiment, the 30 insoluble fiber is soy fiber. In another embodiment, the fiber is corn plant fiber. In another embodiment, the fiber is corn bran fiber. In another embodiment, the insoluble fiber is cellulose. In another embodiment, the insoluble fiber is bacterial cellulose. In another embodiment, the insoluble fiber is wheat bran fiber. In another embodiment, the fiber is oat bran fiber. In another embodiment, the insoluble fiber is rice bran fiber. In another embodiment, the fiber is pea hull fiber. In another embodiment, the insoluble fiber is bamboo fiber.

Numerous sources for the insoluble dietary fibers are readily available and known to one skilled the art. For example, corn bran fiber is available from Quaker Oats of Chicago, Ill. and FiberGel Technologies Inc., Mundelein, Ill., a subsidiary of Circle Group Holdings Inc.; oat hull fiber is available from Canadian Harvest of Cambridge, Minn.; pea hull fiber is available from Woodstone Foods of Winnipeg, Canada; soy hull fiber and oat hull fiber is available from The Fibrad Group of LaVale, Md.; soy cotyledon fiber is available from Protein Technologies International of St. Louis, Mo.; sugar beet fiber is available from Delta Fiber Foods of Minneapolis, Minn.; chicory root fiber is available from Cargill Health & Food Technologies, Minneapolis, Minn. and Imperial Sensus in Sugar Land, Tex.; bamboo fiber is available from CreaFill Fibers Corp., Chestertown, Md.; wheat bran fiber is available from Cargill Foods, Minneapolis, Minn.; wheat plant fiber is available from Josef Ehrler GmbH & Co. KG, Rosenberg-Ludwigsmühle, Germany; cellulose is available from the James River Corp. of Saddle Brook, N.J. and International Fiber Corporation, of North Tonawanda, N.Y.; bacterial cellulose is available from CP Kelco, Chicago, Ill. and from Ajinomoto Co., Kawasaki, Japan; and microcrystalline cellulose is manufactured and sold by FMC Corporation, Food Ingredients Division, Philadelphia, Pa.

5. Gelling Agent

The low calorie sugar substitute compositions disclosed herein include a gelling agent. The gelling agent is a polymer or polymer mixture that is capable of forming a gel. Specifically, the polymer or polymer mixture can interact to form an interwoven, continuous polymer network or to form a non-continuous network of polymer particles that interact to form an aqueous gel.

The gelling agent can be a polymer of natural origin or can be synthetic, and one or more gelling agents in combination can be used. Generally, the gelling agent can a polysaccharide, a protein or a synthetic polymer. The polymer, or one or more polymers in a mixture of polymers, can be a chemically modified natural polymer, such as, but not limited to, a polysaccharide, that has been chemically treated to provide or alter substituent groups thereon. The polymer mixture can contain a synthetic polymer together with a natural polymer. In one embodiment, the polymer that is used includes a polysaccharide of natural origin.

a. Polysaccharides

Gelling polysaccharide polymers are well-known in the art (see, e.g., Clark, “Gels and gelling” in Physical Chemistry of Foods, Schwartzberg and Hartel, editors; published by Marcel Dekker, 1992). Polysaccharide gelling agents that can be transformed from a liquid state to a semi-solid or solid state include, but are not limited to, carrageenan, agar, gellan gum, pectin, gelatin, xanthan gum/locust bean gum, konjac glucomannan, furcelleran, chitosan, modified starch, curdlan and alginate. In one embodiment, cold water soluble polymers are used because of their ability to form gels at room temperature without the need for heating and cooling. An example of a cold water soluble gelling agent is sodium alginate.

One polysaccharide that can be used as a gelling agent in the low calorie sugar substitute composition provided herein is, for example, algin or alginate. Alginates are well-known in the art (see, e.g., McNeely and Petite, Algin, in “Industrial Polysaccharides” by Whistler and BeMiller (2^{nd} Edition, 1973, Academic Press, NY); “Alginate Products for Scientific Water Control,” Kelco Division of Merck & Co., Inc. (April 1987); “Structured Foods with the Algin/Calcium Reaction,” Technical Bulletin F-83, Kelco Division of Merck & Co., Inc. (1994); Kuntz, “Special Effects With Gums,” Food Product Design, December 1999); Draget et al., “Alginates from Algae,” in Biopolymers, Polysaccharides II: Polysaccharides from Eukaryotes (E. J. Vandamme, ed.; 2002 Wiley-VCH Verlag GmbH, pp. 215-240); and Tombs et al., “Alginates and Brown Seaweed” in An Introduction to Polysaccharide Biotechnology (1998, Taylor & Francis, Inc. Bristol, Pa., pp. 123-133).

Alginate is a linear co-polymer composed of two monomeric units—D-mannuronic acid and L-guluronic acid. These monomers occur in the alginate molecule as regions made up exclusively of one unit or the other, referred to as M-blocks or G-blocks, or as regions in which the monomers approximate an alternating sequence. The calcium reactivity of alginates is a consequence of the particular molecular geometries of each of these regions. Because of the particular shapes of the monomers and their modes of linkage in the polymer, the geometries of the G-block regions, M-block regions, and alternating regions are substantially different. Specifically, the G-blocks are buckled while the M-blocks have a shape referred to as an extended ribbon. If two G-block regions are aligned side by side, a diamond shaped hole results. This hole has dimensions that are ideal for the cooperative binding of divalent ions, such as calcium ions.

When calcium ions are added to a sodium alginate solution, an alignment of the G-blocks occurs, with the calcium ions bound between the two chains like eggs in an egg box. The calcium reactivity of algins is the result of calcium-induced dimeric association of the G-block regions. Depending on the amount of calcium present in the system, these inter-chain associations can be either temporary or permanent. With low levels of calcium, temporary associations are obtained, giving rise to highly viscous, thixotropic solutions. At higher calcium levels, gelation results from permanent associations of the chains. At even higher calcium levels, precipitation results.

Commercial alginates are derived from a variety of seaweed sources. Since different seaweeds yield alginates that differ in monomeric composition and block structure, a given alginate has its own characteristic calcium reactivity and gelation properties. Although the ratio of mannuronic acid to guluronic acid (M:G ratio) can be obtained relatively easily, the detailed molecular compositions of alginates in terms of block lengths and block distributions are much more difficult to determine. As a result, alginates are usually referred to as “high M” or “high G”, depending on the proportions of mannuronic acid and guluronic acid they contain. Most commercial products are of the high M type, the best example being the alginate obtained from giant kelp, Macrocystis pyrifera, harvested off the California coast. Laminaria hyperborea provides a high G alginate. In general terms, high G alginates produce strong, brittle gels that are heat stable, while high M alginates provide weaker, more elastic gels that have less heat stability but more freeze/thaw stability. Final gel strength, however, can be adjusted by manipulation of the gel chemistry and in some product situations, high G and high M alginates are interchangeable. Many different factors influence the characteristics of an algin aqueous gel, including, but not limited to, the effects of concentration of alginate, its molecular weight, its structure and weed source, the presence of any calcium remaining in the alginate from the extraction process, pH, temperature and the presence of other salts. These factors and their influence are known to the skilled artisan (see, e.g., King (“Brown seaweed extracts (alginates),” pp. 115-188, in M. Glicksman (ed). Food Hydrocolloids, Vol II (Boca Raton, Fla.: CRC Press,1983); Clare, K., “Algin,” pp. 105-143, in R. L. Whistler and J. N. BeMiller (eds), Industrial Gums, San Diego, Calif.: Academic Press. (1993).

Another polysaccharide that can be used as a gelling agent, for example, is carrageenan, especially kappa carrageenan. Carrageenans are known to those skilled in the art (see, e.g., Stanley, “Carrageenans” in Food Gels (Peter Harris, ed. (London: Elsevier Applied Science, Elsevier Applied Food Science Series (1990), ISBN 1-85166-441-6; and Towle, “Carrageenans” in Industrial Gums by Whistler and BeMiller (2^{nd} Edition, 1973, Academic Press, NY). Kappa carrageenans are a class of polysaccharides which occur in some red seaweed species. They are linear polysaccharides made up from alternating β-1,3- and α-1,4-linked galactose residues. The 1,4-linked residues are the D-enantiomer and sometimes occur as the 3,6-anhydride. Many of the galactose resides are sulfated. A number of carrageenan structures have been described and commercial materials are available which approximate to the ideal structures. Variations between these structures occur, depending on the source of the carrageenan and the treatment of it after extraction.

Kappa carrageenan is sulfated on the 1,3-linked galactose residues, but not on the 1,4-linked resides. Iota carrageenan is sulfated on both residues. Lambda carrageenan has two sulfate groups on the 1,4-linked residues and one sulfate group on 70% of the 1,3-linked residues. Other types of carrageenan can be used in mixtures with kappa carrageenan. Aqueous solutions of iota carrageenan exist as reversible gels, and these are self healing. Lambda carrageenan on its own in aqueous solution does not form gels because its higher charge density inhibits association between molecules and consequent structuring in liquids. Some lambda carrageenan can be included in mixtures with kappa carrageenan. If lambda carrageenan is included in a mixture of carrageenans, the mixture can contain a majority (more than half of the polysaccharide) of kappa or kappa and iota carrageenan with a minority proportion of lambda carrageenan. Methods of using carrageenans to form aqueous gels are known in the art (see, e.g., van de Velde, “Carrageenans,” in Biopolymers, Polysaccharides II: Polysaccharides from Eukaryotes (E. J. Vandamme, ed.; 2002 Wiley-VCH Verlag GmbH, pp. 245-274); and Tombs et al., “Carrageenans and Red Seaweed” in An Introduction to Polysaccharide Biotechnology (1998, Taylor & Francis, Inc. Bristol, Pa., pp. 134-140).

Another polysaccharide that can be used as a gelling agent is, for example, furcelleran. Furcellerans are known to the skilled artisan (see, e.g., Bjerre-Petersen et al., “Furcelleran” in Industrial Gums by Whistler and BeMiller (2nd Edition, 1973, Academic Press, NY). Furcelleran is similar to kappa carrageenan and differs from kappa carrageenan in that it is only partially sulfated on the 1, 3-linked galactose residues. Its reactivity and gel formation chemistry is similar to carrageenan.

A polymer of bacterial origin that can be used as a gelling agent is, for example, gellan gum. Gellan gum is known to those skilled in the art (see, e.g., Sanderson, “Gellan Gum” in Food Gels (edited by Peter Harris, London: Elsevier Applied Science, Elsevier applied food science series (1990), ISBN 1-85166-441-6). Gellan gum is the extracellular polysaccharide produced by the organism Sphingomonas elodea during aerobic fermentation. The primary structure of gellan gum is composed of a linear tetrasaccharide repeat unit containing glucose, glucuronic acid, glucose and rhamrose residues. The biopolymer is produced with two acyl substituents present on the 3-linked glucose, namely, L-glyceryl, positioned at O(2) and an acetyl substituent at O(6). The degree of acylation influences the resulting gel. Low acyl gellan gum produces firm, brittle gels which are very heat stable. High acyl gellan gum produces soft, elastic gels which are thermo-reversible. Blends of the high acyl and low acyl gellan gums can be used to formulate gels of intermediate hardness and varying degrees of heat stability. The low or high acyl gellan gums or blends thereof can be used as a gelling agent in the compositions provided herein.

Polysaccharide blends that form gels upon interaction are know in the art (see, e.g., Wanous, “Texturizing and Stabilizing, by Gum! Multifinctional hydrocolloids,” Prepared Foods ( January, 2004). An example are the synergistic gels formed by the interaction of glucomannans or galactomannans with xanthan gum or with carrageenan. In general, a glucomannan or a galactomannans with sequences of continuous mannose residues in its polymer chain, such as locust bean gum, tara gum, guar gum or konjac mannan, when mixed and heated with a second polysaccharide, for example, xanthan gum or carrageenan, interact to form entangled polymer molecules that form a continuous and branched network which extends throughout the sample.

Many of the polymers noted above, when in aqueous solution, form so-called reversible gels that melt when heated, but revert to gels when cooled. A well known example of a polysaccharide that forms a reversible gel is agar. An aqueous solution containing a small percentage of agar is a mobile liquid when hot, but when left to cool it forms a gel with sufficient rigidity to maintain its own shape. Other polymers that can form reversible gels include, for example, methyl cellulose, carrageenan, furcellaran, gellan gum and pectin.

Many of the polymers noted above also can be formulated to form so-called irreversible gels that do not melt when heated. The thermal stability can be manipulated by controlling the amount and type of counter ions in the formulation. For example, higher levels of calcium ions tend to favor formation of thermally stable gels. When subjected to heat, such as that experienced during cooking and baking, the gel does not melt but remains in a gelled state. Polymers that can form irreversible gels include, but are not limited to, alginate, chitosan, konjac glucomannan and gellan gum.

The formation of gels by natural and synthetic polysaccharides arises from interaction between the polymer molecules. Reversible gels generally display a melting temperature or temperature range, referred to as the gel point. This is the temperature at which, on slow heating, the gel is observed to melt as this interaction largely disappears. Thus, above the gel point, the hot solution of polymer is mobile. When it cools below its gel point, the interaction of polymer molecules enables them to form a continuous and branched network which extends throughout the sample. In contrast with the formation of a continuous, branched network, some other materials that thicken water do so through merely local, transient entanglement of molecules.

b. Proteins

A number of gel-forming proteins are known to those skilled in the art (see, e.g., Yada, Proteins in Food Processing (Woodhead Publishing Limited, 2004); Hegg, “Conditions for the Formation of Heat-Induced Gels of Some Globular Food Proteins,” Journal of Food Science. Vol. 47 (1982), pp. 1241-44). These gel-forming proteins include, but are not limited to, gelatin, conalbumin, serum albumin, β-lactoglobulin, whey protein and soy protein. Many of the proteins form irreversible gels upon heating, such as the albumins. Soy protein can form gels that are thermally reversible. Any of the gel-forming proteins, alone or in any combination, can be used as a gelling agent in the low calorie sugar substitute composition provided herein.

6. Gel Activator

A gel activator can be used to cause gelation of the gelling agent to form the aqueous gel composition provided herein. Gel activators are known to the skilled artisan and are typically salts that provide cations capable of converting a solution containing the gelling agent into a gelled form. Depending on the gelling agent selected, suitable cations are typically sodium, potassium and calcium. A gel activator can include any of the following used alone or in combination: potassium salts, including chlorides, phosphates, citrates, lactates, acetates, carbonates, sulfates and gluconates; sodium salts, including chlorides, phosphates, citrates, lactates, acetates, carbonates, sulfates and gluconates; and calcium salts, including chlorides, phosphates, citrates, lactates, acetates, carbonates, sulfates and gluconates.

For example, when sodium alginate is used as a gelling agent, calcium ions, for example, can be used to convert the alginate into a gelled form, and suitable gel activators to provide calcium include, but are not limited to, dicalcium phosphate anhydrous, dicalcium phosphate dehydrate, calcium sulfate, calcium lactate and calcium gluconate. When pectin is used as the gelling agent, calcium ions, for example, can be used to convert the pectin into a gelled form. When kappa carrageenan is the gelling agent, gelation occurs with, for example, potassium ions to form strong, brittle gels. The rigidity of the gel increases with increasing potassium ion concentration. When iota carrageenan is used as the gelling agent, gelation occurs with, for example, calcium ions to form cohesive elastic gels. When gellan gum is used as the gelling agent, a number of different cations, for example sodium, potassium or calcium ions, can be used to cause gelation. The particular gel activator to be used with a given gelling agent can be empirically determined, such as by testing the gel strength of the resulting gel (see, e.g., Wilkes, “Evaluating Gel Strength,” Food Product Design, March 1992).

C. Preparation of the Compositions

The compositions provided herein can be prepared according to methods known to those skilled in the art. Such methods include any known to those of skill in the art and those provided below and exemplified herein. The methods include dispensing the components of the aqueous gel into an appropriate mixing vessel and mixing the components until a substantially homogeneous mixture is made, and then dispensing the mixture into appropriate containers.

A feature of the disclosed aqueous gel composition is its simplicity of make-up. No specialty equipment is required for preparation of the composition. Mixing equipment that is typically available to those skilled in the art can be used to prepare the disclosed compositions. The components of the compositions provided herein are usually mixed in a mixer capable of generating sufficiently high shear to at least substantially avoid or minimize the initial formation of lumps of the thickener and/or gelling agent upon addition to the water of the formulation, or to mix the ingredients to a uniform homogeneity. Suitable high shear mixing devices that can be used include, but are not limited to, Waring blenders, Norman mixers, a Breddo Likwifier, manufactured by Breddo Food Products Corporation, Kansas City, Kans., and vessels equipped with high speed impellers sufficient to produce a vortex to mix the components.

Generally, the liquid components of the formulation are added to the mixer, and agitation is started. While the liquid is being agitated and is subject to shear, the dry ingredients, separately or in combination, and in any order, are added to the liquid under sufficient shear to bring about effective dispersion and hydration known to those of skill in the art. Clumping, or the formation of local concentrations of particulate, such as the gelling agent or thickener, commonly referred in the industry as the formation of “fish eyes,” can occur during addition of dry ingredients to the liquid. Clumping tends to occur upon the contact of the powdered gelling agent or thickener with the water or aqueous solution, and can be avoided or at least minimized by agitation of the aqueous solution using high shear mixing during addition of the gelling agent and/or thickener.

Conditions for dispersing and hydrating hydrocolloids are well known in the art. One established technique for facilitating dispersion and hydration is to pre-blend the dry ingredients of a formulation, alone or in any combination, in a dispersing agent such as oil, alcohol, polyol or propylene glycol. Such dispersing agents can be used during make-up of the composition disclosed herein. In one embodiment, the gelling agent and/or thickener is mixed, separately or in combination, with a portion of the polyol of the formulation, to make a slurry or dispersion of the thickener and/or gelling agent. Another method to minimize clump formation is using a mixing eductor to rapidly disperse the dry ingredients, such as the thickener and/or gelling agent, alone or in any combination, into the aqueous solution. For example, see Technical Bulletin DB-19, “Making Solutions of Kelco Polymers,” Kelco Division of Merck & Co., Inc (April, 1992). The mixing is continued until at least substantial homogeneity is achieved.

To provide microbiobial stability during storage, anti-microbial agents, anti-mycotic agents or preservatives, alone or in any combination, optionally can also be included in the composition. The anti-microbial agents, anti-mycotics and preservatives include all anti-microbial agents, anti-mycotics and preservatives known to those skilled in the art. Exemplary suitable anti-microbial agents include, but are not limited to, nisan, natamycin, calcium sorbate, sodium sorbate, potassium sorbate, benzoic acid, sodium benzoate, potassium benzoate, butyl p-hydroxybenzoate, and mixtures thereof. Exemplary suitable anti-mycotic agents include, but are not limited to, natamycin, pimaricin, vanillin, citral, calcium propionate, sodium propionate, and mixtures thereof. Exemplary suitable preservatives include, but are not limited to, sodium benzoate, benzoic acid, sorbic acid, calcium propionate, sodium propionate, potassium sorbate, calcium sorbate, benzoic acid, sodium benzoate, potassium benzoate and mixtures thereof.

The optional anti-microbial agents, anti-mycotic agents or preservatives can be used in effective amounts which do not adversely affect the taste or smell of the final composition. Suitable amounts range from about or at 0.0025% to about or at 0.30% by weight, based upon the weight of the low calorie sugar composition. The optional anti-microbial agents, anti-mycotic agents or preservatives can be incorporated into the gel composition by adding them, for example, to the water or aqueous mix, either directly or as a premix with any of the other composition ingredients so as to distribute it substantially uniformly throughout the composition. In addition, oxidation stabilizers such as BHA or BHT can be used. These can be conventionally added, for example, to the water along with the polyol and the high intensity sweetener. The amount of anti-microbial agents, anti-mycotic agents or preservatives to be added can be determined empirically.

The gel activator can be dissolved in water or made into a slurry using one of the dispersing agents as discussed above. The gel activator can be added in any sequence of the make-up procedure. For example, the gel activator can be added as the last ingredient in the mixing process.

Through appropriate selection of the gel activator and the gelling agent, the composition is converted during preparation from a flowable liquid to a viscoplastic fluid to form an aqueous gel. A viscoplastic fluid is a fluid characterized as a non-Newtonian fluid that is a “solid-like” composition that does not flow until a certain amount of stress is applied to the composition. In the context of the composition provided herein, “solid-like” means that when a sample is removed from the composition with a spoon, the depression created by removal of the sample remains, and does not start to be filled up by material flowing from the walls of the depression immediately after the spoon is removed. The compositions provided herein have a gelled “solid-like” structure, and a certain amount of stress must be applied to the compositions before flow occurs. The fluid then exhibits a pseudoplastic flow behavior—it exhibits a decreasing viscosity with increasing shear. This characteristic makes the aqueous gel composition provided herein easily pumpable during manufacture and commercial use, and easily incorporated into food formulations. The amount of gel activator to be added to the composition to achieve a viscoplastic aqueous gel can be calculated or determined empirically. For example, in one embodiment, the gelling agent is sodium alginate and the gel initiator is a source of calcium ions. The reaction between calcium ions and algin molecules is:
2NaAlg+Ca⁺⁺→2CaAlg+2Na
where NaAlg is sodium alginate and CaAlg is calcium alginate. The theoretical calcium conversion equation is:

$$\% Calcium conversion = \frac{( \% Ca ) \cdot 10.7}{\% total soluble algin} \times ( 100 \% )$$

The correction factor “10.7” is derived from the theoretical weight of 1 subunit of algin divided by the weight of one-half mole of calcium, or 214/20=10.7. The total soluble algin is equal to the total algin in the system adjusted for moisture in the algin powder, which is generally from 5% to 10%. Free calcium in the system, such as from hard water or from calcium in dairy products, must be taken into consideration when theoretically calculating the calcium conversion of algin.

As calcium ions are added to the system, the reaction proceeds to the right until the alginate is precipitated as calcium alginate. In most applications, such as in the compositions provided herein, control of the calcium reaction can be accomplished is several ways:

1. Calcium salts can be used that are insoluble at selected temperatures;

2. Variation in pH can be used during manufacture to control calcium salt ionization;

3. Readily soluble sequestrants, both permanent and fugitive, can be used to adjust setting time and vary final gel strength and texture;

4. Variations in the solubility of various acids due to particle size and chemistry can be utilized to control reaction rate or setting time of the gel; and

5. High levels of solids, such as polyols, can be used to inhibit the reaction and modify the gel texture and gel strength.

For the low calorie sugar substitute composition provided herein, when, for example, alginate is used as the gelling agent, the gel activator is generally a source of calcium ions that are released under controlled conditions from within the system. When a cold water soluble gelling agent, such as alginate, is selected, external heating or cooling is generally not needed in preparing the compositions provided herein. Conveniently, the gels are prepared under ambient conditions with the ingredients being heated only by the heat generated during high shear mixing. Generally, mixing temperatures range from about or at 65° F. up to about or at 85° F. Although the detailed reaction kinetics are extremely complex, involving both high molecular weight polymers and small organic and inorganic molecules, a qualitative understanding of the reaction, sufficient for practical purposes, has been acquired by those skilled in the art.

The rate at which the calcium ion is made available to the alginate molecules depends primarily on pH and the amount, particle size and intrinsic solubility characteristics of the calcium salt. Small particle size and low pH favor rapid release of calcium. Calcium salts that are used to gel alginate in food systems include, but are not limited to, calcium chloride, calcium gluconates, calcium acetate monohydrate, monocalcium phosphate monohydrate, calcium lactate, calcium sulfate dehydrate, calcium sulfate anhydrous, calcium citrate, calcium tartrate, dicalcium phosphate dehydrate, dicalcium phosphate anhydrous, tricalcium phosphate and precipitated calcium carbonate.

In order to delay calcium release during the mixing of the ingredients, a calcium sequestrant optionally is used to control the reaction by competing with the alginate for calcium ions. Typical food-approved sequestrants, include, but are not limited to, sodium hexametaphosphate, tetrasodium pyrophosphate, sodium acid pyrophosphate, trisodium phosphate anhydrous, sodium tripolyphosphate, disodium phosphate and sodium citrate. Although disodium phosphate (disodium hydrogen orthophosphate) has little affinity for calcium at pH less than 5, it is sometimes usefully employed in the preparation of alginate gels to remove (as insoluble dicalcium phosphate) calcium ions from tap water. Removal of these ions permits more efficient hydration and subsequent gelation of the alginate.

For a given level of alginate and calcium salt, an increase in the level of sequestrant causes a decrease in the setting rate of the gel. This results in a progressively weaker final gel, since the ultimate distribution of the calcium ions between the alginate and the sequestrant increasingly favors the latter. In other words, the so-called conversion of the sodium alginate into the gelled calcium form is progressively reduced. Control of the gelling reaction with sequestrants is only necessary during mixing to prevent premature gelation. With highly efficient and rapid-mixing equipment, only a relatively small amount of sequestrant is required because only a small proportion of the calcium salt has the opportunity to dissolve during the mixing process. In these situations, extremely fast setting, strong gels can be obtained.

The rate of gelation of alginate can also be controlled by the optional use of known edible pH adjusters, such as buffering systems, organic acids, acidic salts and alkaline salts. The pH adjusters inhibit or promote reaction between the calcium ion source and the alginate by controlling the solubility of the calcium ion source. Generally, lowering the pH increases the solubility of the calcium ion source which promotes its reaction with the gelling agent. Increasing the pH generally decreases the solubility of the calcium ion source or sequesters the calcium ion which inhibits reaction with the gelling agent.

Exemplary of suitable alkaline salts are sodium citrate, sodium acetate, and sodium ascorbate. A suitable acidic salt is sodium acid pyrophosphate. Suitable organic acids include citric acid, acetic acid, malic acid, fumaric acid, ascorbic acid, and the like. Exemplary of suitable buffering systems are sodium citrate and citric acid, sodium acetate and acetic acid, and sodium ascorbate and ascorbic acid. The amount of organic acid, acidic salt, or buffering system optionally added is generally sufficient to provide a pH of between about or at 3.5 to about or at 7.5, and usually between about or at 4.5 to about or at 6.5, to increase the solubility of the calcium ion source subsequently added. Higher pH values, obtained with an appropriate amount of an alkaline salt, are generally used to impede the reaction between the calcium ion source and the gelling agent.

When a pH adjuster is included in the formulation, the pH adjuster is generally dissolved in an amount of water sufficient to form a solution prior to adding to the water of the composition. The pH adjuster is usually added prior to the addition of the gelling agent and gel activator. When an alkaline salt is used to inhibit the reaction between the calcium ion and the alginate, reaction between the calcium ion and alginate then can be subsequently promoted by the addition of an edible organic acid, a buffer system or an acidic salt. The subsequently added acidic agent is usually added in an amount of water sufficient to solubilize it. The amount of acidic agent again should generally be sufficient to provide a pH of between about or at 3.5 to about or at 7.5, usually between about or at 4.5 to about or at 6.5. Upon its addition, mixing is continued to obtain a substantially homogeneous mixture.

In one embodiment, some of the ingredients can be preblended prior to adding to the water of the formulation. For example, the thickener and/or the gelling agent can be preblended with a suitable amount of the polyol to make a slurry such that the thickener and/or gelling agent is more easily dispersed when added to the water. Suitable low shear mixers can be used for preblending of ingredients. Such low shear mixers include, but are not limited to, Hobart mixers, Ribbon mixers, Sigma blade mixers and Littleford mixers.

After the mixing of all of the components of the composition is completed and a substantially homogenous mixture is achieved, the resulting mixture is dispensed into containers, such as containers that then can be sealed, and the mixture is allowed to set into a viscoplastic aqueous gel. The composition usually sets up into a viscoplastic aqueous gel, having a “solid-like” consistency, in about or at 2 hours to about or at 24 hours. For example, the composition is allowed to set for 2, 3, 4, 5, 6, 7, 8, 9, 10, 11, 12, 13, 14, 15, 16, 17, 18, 19, 20, 21, 22, 23 or 24 hours to form a viscoplastic aqueous gel. After the composition has set, the containers can be sealed and stacked and stored or can be shipped to their final destination for incorporation into a comestible.

For example, in one embodiment, the polyol is sorbitol, the gelling agent is sodium alginate and the gel activator is a source of calcium ions. The principles involved in making alginate gels through interaction between alginate and calcium ions are well known to those of ordinary skill in the art and are wholly described in the literature as discussed above. For example, preparation of alginate gels containing corn syrups is disclosed by Vanderveer et al. in U.S. Pat. No. 4,624,856. Procedures similar to those described by Vanderveer et al. can be used to prepare the compositions disclosed herein. Unlike the gels described by Vanderveer et al. in U.S. Pat. No. 6,624,856, the compositions provided herein are formulated to avoid over-conversion of the sodium alginate to calcium alginate, so that the end product is not a rigid gel that must be comminuted into pieces prior to being used as an ingredient in a baked product but, rather, is a gelled viscoplastic fluid that is sufficiently soft to allow it to be incorporated into a food formulation in a similar manner to shortening, an ingredient that the food industry, particularly the bakery trade, is accustomed to using. For example, the calcium conversion of the algin in the compositions provided herein can be in a range of from about or at 10% to about or at 95%, or any integer in between. In one embodiment, the calcium conversion of the algin is from about or at 20% to about or at 80%. In another embodiment, the calcium conversion of the algin is 10%, 15%, 20%, 25%, 30%, 35%, 40%, 45%, 50%, 55%, 60%, 65%, 70%, 75%, 80%, 85%, 90% or 95%.

The viscoplastic gelled structure of the low calorie sugar substitute composition provided herein makes it easy to be incorporated in food formulations. The viscoplastic gelled structure also offers other advantages. For example, the gelled structure provides an effective means for uniformly dispersing a high intensity sweetener throughout the formulation during manufacture so as to avoid “hot spots” of high intensity sweetener in the final comestible. In addition, the composition provided herein increases moisture retention within the comestible in which the low calorie sugar substitute composition provided herein is incorporated, providing humectancy and moisture retention above that obtained by inclusion of polyols alone or in a composition used in an ungelled state. The gelled structure also limits absorption of any water included separately as another formulation ingredient. In the absence of a gelled structure, the components of the composition, notably the thickener and polyol, tend to absorb and bind too much water from the formulation, resulting in a less appealing food product. The compositions provided herein thus allow sugar and other caloric sweeteners such as corn sweeteners, to be replaced in whole or in part by a material that not only provides body, texture, sweetness, humectancy, and freeze/thaw stability but also, through balanced distribution of water both within and without the composition, uniform moistness and, in the case of baked products, added tenderness throughout the product in which it is incorporated.

D. Articles of Manufacture

The low calorie sugar substitute compositions provided herein can be packaged as articles of manufacture. For example, in one embodiment, the aqueous gel composition provided herein is packaged into a container with a label that indicates that the composition is used for replacing at least a portion of the caloric sweetener, such as sugar or corn sweeteners, in a comestible. The container can be of any size. For example, for home consumer use, the article of manufacture can include the aqueous gel compositions provided herein packaged in a sealed container, packet, tub, pail or bucket or a re-sealable container, packet, tub, pail or bucket. For commercial use, the article of manufacture can include the low calorie sugar substitute compositions provided herein packaged in a sealed packet, tub, pail, bucket, barrel or drum, or a re-sealable packet, tub, pail, bucket, barrel or drum. For large-scale manufacturing facilities, the aqueous gel composition can be packaged in tote bins known to those skilled in the art, such as those that can hold hundreds of gallons of liquid. The aqueous gel composition provided herein can also be loaded into a tanker truck or rail car and delivered to a manufacturing site.

Another article of manufacture is a packaged ready-to-prepare comestible formulation that includes the aqueous gel composition provided herein. Such formulations can include, but are not limited to, packaged slice-and-bake refrigerated cookie dough, packaged place-and-bake frozen cookie dough, microwave-ready brownie and cake batters, ice cream mix, milk shake mix and frozen yogurt mix.

Another article of manufacture is a packaged ready-to-eat comestible that includes the aqueous gel composition provided herein. Examples of such articles of manufacture are packaging materials that include, but are not limited to, bakery goods, such as cakes, crackers, cookies, brownies, muffins, rolls, bagels, strudels, pastries, croissants, biscuits, bread, and bread products (e.g. pizza), buns, and fillings and jellies; frozen desserts, such as ice cream, frozen yogurt, frozen custard, ice milk, sherbet, frozen novelties, frozen dairy confections and non-dairy frozen confections such as water ices and frozen fruit bars; processed flavored dairy drinks; egg nogs; breakfast bars; custards; puddings; salad dressings; sauces; icings, confections and confection toppings; syrups and flavors; pie fillings; sports drinks; nutrition bars; nutrition gels; probiotic yogurt and cultured dairy foods.

E. Kits

Any of the compositions provided herein can be supplied in a kit along with instructions for conducting any of the methods disclosed herein, such as for preparing a comestible. Such kits include, but are not limited to, a package that includes the aqueous gel composition provided herein, ingredients to make or formulate a comestible, and appropriate instructions for making or formulating the comestible. In one embodiment, the kit includes a container that includes the aqueous gel composition provided herein, a separate container or containers that include other ingredients of a comestible, and instructions for combining the aqueous gel composition with the other ingredients. The instructions can also include assembly directions, for example, the mixing procedures and processing temperature suggested for proper preparation of the components into a comestible.

The instructions can be in any tangible form, such as printed paper, a computer disk that instructs a person how to conduct the method, a video cassette or digital video device containing instructions on how to conduct the method, or computer memory that receives data from a remote location and illustrates or otherwise provides the instructions to a person (such as over the Internet).

In one embodiment, the kit includes the aqueous gel composition provided herein, ingredients for formulating or making a baked good, and instructions for combining the ingredients in the kit optionally with other ingredients to formulate or make the baked good. As an example, a kit for making a low calorie cake can include a container that includes the aqueous gel composition provided herein, a container that includes flour, flavorings, emulsifiers and leavening agents, and instructions for making a low calorie cake that include adding additional ingredients, such as eggs, water and fat, to the components of the kit, mixing the components together to form a mix and baking the mix. Another example of a kit provided herein is a kit for the preparation of a low sugar ice cream, where the kit includes a container that includes the aqueous gel composition provided herein, a container that includes a flavor, and instructions for blending the components of the kit with other ingredients of an ice cream mix, such as, but not limited to, milk, cream and milk solids, to make a low sugar ice cream. The instructions can also include recommended mixing and freezing conditions to produce the low sugar ice cream.

In another embodiment, the kit includes a container including an aqueous gel composition provided herein, a container including soluble fiber, and instructions for combining the components of the kit with other ingredients to formulate a comestible. In another embodiment, the kit includes a container including an aqueous gel composition provided herein, a container including insoluble fiber, and instructions for combining the components of the kit with other ingredients to formulate a comestible.

Another embodiment is a kit that includes the aqueous gel composition provided herein, appropriate instructions, and at least a portion of the ingredients to make a comestible selected from among bakery goods, such as cakes, crackers, cookies, brownies, muffins, rolls, bagels, strudels, pastries, croissants, biscuits, bread, and bread products (e.g. pizza), buns, and fillings and jellies; frozen desserts, such as ice cream, frozen yogurt, frozen custard, ice milk, sherbet, frozen novelties, frozen dairy confections and non-dairy frozen confections such as water ices and frozen fruit bars; processed flavored dairy drinks; egg nogs; breakfast bars; custards; puddings; salad dressings; sauces; icings, confections and confection toppings; syrups and flavors; pie fillings; sports drinks; nutrition bars; nutrition gels; probiotic yogurt and cultured dairy foods.

Another embodiment is a kit that includes the aqueous gel composition provided herein and instructions for using the composition to improve the organoleptic properties of a comestible. Another embodiment is a kit that includes the aqueous gel composition provided herein and instructions for using the composition to retard moisture migration in a baked good product. Another embodiment is a kit that includes the aqueous gel composition provided herein and instructions for using the composition to extend the shelf life of a baked good product.

F. Methods of use of the Compositions

The compositions can be used to prepare or formulate food products in which a significant reduction in calories can be achieved. Sugars provide about 4 Kcal/g and sobitol provides 2.6 Kcal/g. Thus, by way of example, using 50 g of a composition provided herein that contains 35% sorbitol, to replace 100 g of dry sugar, the calorie contribution is reduced from 400 Kcal/g to 45.5 Kcal/g, or by around 90%. In addition, these composition levels not only provide a significant reduction in calorie intake, but also limit the amount of polyol consumed, thereby substantially reducing or eliminating any potential laxative effect caused by polyol.

1. Use Level

The use level of the low calorie sugar substitute provided herein in comestibles can be determined empirically, such as by varying the amount used and testing the resulting comestible. The use level of the aqueous gel low calorie sugar substitute composition provided herein is generally from about or at 40% to about or at 60% of the caloric sweetener replaced. The use level of the aqueous gel low calorie sugar substitute composition provided herein can be 40%, 42%, 44%, 46%, 48%, 50%, 52%, 54%, 56%, 58% or 60% of the caloric sweetener replaced. In one embodiment, the use level is about or at 50% of the sugar or corn sweetener replaced. By way of explanation, for illustrative purposes, in a recipe calling for 10 pounds of sugar, the low calorie sweetener provided herein can be used to replace all of the sucrose, and can be used, for example, at from about or at 4 pounds to about or at 6 pounds. The replacement can be weight by weight or volume by volume. For example, 10 pounds of sugar can be replaced with 4, 4.5, 5, 5.5 or 6 pounds of the low calorie sugar substitute provided herein.

As another example, 10 cups of sugar can be replaced with 4, 4.5, 5, 5.5 or 6 cups of the low calorie sugar substitute provided herein. For example, replacing all of the sugar used in a traditional cookie recipe with an amount of the low calorie sugar substitute composition provided herein equal to 50% of the sugar results in a cookie that bakes under similar conditions to the traditional cookie, and produces a cookie having a crisp crust while being moist on the inside, and the cookie demonstrates a shelf life similar to the traditional cookie in that it does not dry out over a short period of time. The low calorie sugar substitute can also be used to replace only a portion of the sugar or corn sweetener in the formulation of a comestible.

2. Bulking Agents

In some embodiments, soluble or insoluble fiber optionally can be used in addition to the aqueous gel low calorie sugar substitute composition provided herein to replace a portion or all of the remaining bulk of the caloric sweetener replaced. For example, in a recipe calling for 10 pounds of sugar, the low calorie sweetener provided herein can be used to replace all of the sucrose, and can be used, for example, at 5 pounds in the formulation, and the remaining 5 pounds of bulk normally contributed by the sugar optionally can be replaced with a soluble or insoluble fiber as a bulking agent, or with nothing. The low calorie sugar substitute composition provided herein can also be used to replace only a portion of the sucrose. The amount of low calorie sugar substitute composition provided herein required to replace a portion or all of the sucrose or other caloric sweetener in a comestible can be determined empirically. The amount of soluble or insoluble fiber to be added to a formulation can be determined empirically.

a. Moderate to High Solids Systems

It has been found that in some systems having moderate to high solids, such as baked products, especially in cakes and cookies, an insoluble fiber can be used as a bulking agent. It has been found that including insoluble fiber as a bulking agent in combination with the aqueous gel composition provided herein provides the organoleptic properties attributed to the solids contributed by the sugar or corn sweeteners in the traditional recipes, while not drawing moisture from the ingredients in the food product. It has been found that in baked goods, high levels of soluble fiber is deleterious because the soluble fiber can draw so much moisture from the other ingredients that it prevents proper baking of the product, resulting in a comestible that fails organoleptic and sensory testing, and usually is rejected by the consumer. It has been found that insoluble fiber can be used to replace a portion of the bulk provided by sugar or corn sweeteners when using the low calorie sugar substitute composition herein and that the combination provides the texture and organoleptic properties commensurate to comestibles made with sugar or corn sweeteners. The insoluble fiber does not act like a sponge and pull moisture from the product. For example, replacing the traditional sugar and/or corn sweeteners in a cake formulation with the aqueous gel low calorie sweetener composition provided herein and additional insoluble fiber results in a cake that bakes under similar conditions to the traditional cake sweetened with caloric sweeteners, and produces a cake having an even grain and cell structure, a moist and tender crumb, and a smooth uniform soft crust. The cake also displays similar shelf stability as the traditional cake, in that it does not stale or dry out over a short period of time.

The amount of insoluble fiber to be included in a formulation can be determined empirically. Generally, it has been found that including from about or at 10% to about or at 50% of the amount of sugar replaced provides sufficient additional bulk. For example, in a formulation where 10 pounds of sugar is replaced with the aqueous gel composition provided herein, about 1 pound to about 5 pounds of insoluble fiber can be added to the formulation. In one embodiment, an amount of insoluble fiber that is 10%, 12%, 14%, 16%, 18%, 20%, 22%, 24%, 26%, 28%, 30%, 32%, 34%, 36%, 38%, 40%, 42%, 44%, 46%, 48% or 50% of the amount of sugar replaced in the formulation is added. In another embodiment, the insoluble fiber is from about or at 1 part to about or at 30 parts by weight of the comestible. In another embodiment, the insoluble fiber is 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 parts by weight of the comestible.

In another embodiment, at least a portion of the caloric sweetener is replaced with an amount of the low calorie sugar substitute provided herein that is from about or at 40% to about or at 60% of the amount of the caloric sweetener replaced, and an amount of insoluble fiber that is from about or at 10% to about or at 50% of the amount of sugar replaced. In another embodiment, at least a portion of the caloric sweetener is replaced with an amount of the low calorie sugar substitute provided herein that is about or at 50% of the amount of caloric sweetener replaced, and an amount of insoluble fiber that is about or at 25% of the amount of caloric sweetener replaced.

b. Low Solids Systems

In low solids systems, such as frozen fruit bars, and especially low solid systems that do not include fat, such as many frozen ices, it has been found that addition of a soluble fiber as a bulking agent in addition to the low calorie sugar substitute composition provided herein to replace the total solids contributed by the traditional sugar or corn sweeteners results in a product with organoleptic properties similar to the traditional product. For example, in one embodiment, at least a portion of the caloric sweetener in a low solids low-fat or non-fat formulation is replaced with a combination that includes an amount of the low calorie sugar substitute composition provided herein from about or at 40% to about or at 60% of that of the caloric sweetener replaced and an amount of soluble fiber from about or at 60% to about or at 40% of that of the caloric sweetener replaced. For example, in a frozen water ice formulation that includes 6 pounds of sucrose, the sucrose can be totally replaced with a combination of about or at 2.4 pounds of the low calorie sugar substitute composition provided herein and about or at 3.6 pounds of soluble fiber, or the sugar can be replaced with about or at 3.6 pounds of the low calorie sugar substitute composition provided herein and about or at 2.4 pounds of soluble fiber, or any combination thereof in between. The soluble fiber helps to control the growth and size of ice crystal formation during freezing, and contributes to the organoleptic properties of the frozen low solids systems, especially mouthfeel. In systems that include fat, the amount of soluble fiber can be reduced, because the fat in the system helps to control ice crystal formation and texture development. In these systems, the low calorie sugar substitute composition also can be used to replace only a portion of the caloric sweetener.

In one embodiment, an amount of soluble fiber that is 10%, 12%, 14%, 16%, 18%, 20%, 22%, 24%, 26%, 28%, 30%,32%,34%, 36%, 38%, 40%, 42%, 44%, 46%, 48%, 50%, 52%, 54%, 56%, 58% or 60% of the amount of sugar replaced in the formulation is added. In another embodiment, the soluble fiber is from about or at 1 part to about or at 30 parts by weight of the comestible. In another embodiment, the insoluble fiber is 1, 2, 3, 4, 5, 6, 7, 8, 9,10, 11, 12, 13, 14, 15, 16, 17, 18, 19, 20, 21, 22, 23, 24, 25, 26, 27, 28, 29 or 30 parts by weight of the comestible.

3. Baked Goods

In the bakery area, continual efforts are directed towards producing appetizing products which must be pleasing to both the eye and to the palate. Bakers have historically been plagued by the desiccation of baked goods and by the deterioration of the organoleptic properties, including appearance, flavor, and texture resulting therefrom.

This deterioration in texture, appearance and taste of baked goods is believed to be due in part to moisture migrating from the product's high moisture content area to an area with reduced moisture, either into the atmosphere or another portion of the baked good such as into the icing, if present, on the baked good. This moisture migration results in a dried baked good and/or a wetter glaze or icing on the baked good, if present. In any event, as a result thereof, the appearance, taste and texture is unsuitable to the consumer and thus, the moisture migration ultimately results in a shorter shelf-life of the baked good.

Baked goods that can be produced with the low calorie sugar substitute composition provided herein can be classified into three groups. They are products from sweet dough systems, batter systems and topping and creme systems. The dough systems are generally characterized as being a flour-based system whereas the batters, toppings and cremes are more water-based.

Exemplary bakery products which can be manufactured from sweet dough systems include danishes, croissants, crackers, puff pastry, pie crust, biscuits, cookies, and the like. The ingredients of sweet dough systems using the composition disclosed herein include the composition disclosed herein, flour and fat.

Exemplary baked goods products which can be made from batter systems include cakes (such as sponge, foam, devil's food, pound, cheesecake, layer cake and the like), donuts or other yeast raised cakes, brownies and muffins. These products prepared can contain fat, flour, water and the low calorie sugar substitute composition disclosed herein.

The fats or oils used in the comestibles that include the low calorie sugar substitute provided herein can be any edible fat or oil or mixture thereof. They can be plastic or fluid. Examples include vegetable oils, tallow, lard, marine oils and mixtures thereof, which are fractionated, partially hydrogenated and/or inter-esterified. Edible reduced calorie, low calorie or non-digestible fats, fat substitutes or synthetic fats, such as polyesters of sucrose, polydextrose and the like can also be used. Shortenings, fats or mixtures of hard and soft fats can also be used. Moreover, the shortenings can be principally derived from edible triglycerides. Exemplary of the edible triglycerides which can be used include naturally occurring triglycerides derived from vegetable sources, such as cotton seed oil, soybean oil, peanut oil, linseed oil, sesame oil, palm oil, palm kernel oil, rapeseed oil, safflower oil, coconut oil, babassu oil, corn oil and sunflower seed oil mixtures thereof. Marine and animal oil, such as fish oils (e.g., sardine oil, menhaden oil, cod liver oil, omega-3 fatty acids), lard and tallow or hydrogenated lard can also be used. Synthetic triglycerides, as well as natural triglycerides of fatty acid can also be used. The fatty acids can have a chain length of from 8 to 24 carbon atoms. Shortenings or fats which are solid or semi-solid at room temperatures, for example, from about 75° F. to about 95° F., also can be used.

In the batter products, the fat is generally present in amounts ranging from about or at 15% to about or at 30%. The flour is usually present in amounts ranging from about or at 15% to about or at 45%. The low calorie sweetener composition provided herein is generally used at from about or at 40% to about or at 60% of the amount of the caloric sweeter traditionally used, and is usually present from about or at 2 to about or at 60 parts by weight of the baked good. Other additives that are generally present include yeast or chemical leavening agents and salt. Glazes, fillings, icings and jellies which typically contain sweetener (e.g., sugar) and fat as conventional ingredients are examples of products that can be made from topping and creme systems. These toppings and cremes are those that are baked with the dough or batter, not ones that can be applied to the finished bakery product after baking.

The toppings and creme using the compositions provided herein include the disclosed composition, fat and water. In these systems, the low calorie sugar substitute composition is generally present in amounts ranging from about or at 5% to about or at 50%. The fat is usually present in amounts ranging from about or at 15% to about or at 30%.

The exact ingredients in the above exemplary systems and amounts thereof can vary depending on the recipe employed. It is noted that the amounts of the conventional ingredients, including but not limited to, fat and flour, in such baked goods typically is not critical.

Chocolate can be used and it is intended that chocolate is encompassed by the term cocoa. When chocolate is used, it should be in a finely divided form. It may be necessary to reduce the amount of shortening in the mix when chocolate is used because of the additional fat present as cocoa butter. It also may be necessary to add larger amounts of chocolate as compared to cocoa in order to provide an equivalent amount of flavoring and coloring.

The baked goods containing the low calorie sugar substitute compositions provided herein are prepared in accordance with standard techniques, with the low calorie sugar substitute compositions provided herein being added to the ingredients of the baked good product prior to baking. For dough-containing or batter-containing products, the low calorie sugar substitute composition provided herein is added to a flour-containing base batter mix. The expression flour-containing base batter mix as used herein refers to the typical batter or dough compositions for chemically leavened batter system, yeast leavened bread type dough systems, and sweet dough systems. As is well known in the art of preparing a culinary product and comestibles, the precise formulation of the flour-containing base batter mix well vary depending upon the precise bakery product one seeks to make and can be determined empirically.

In the method disclosed herein, the low calorie sugar substitute compositions provided herein can be added to a dry mix or it can be added to a dry mix to which water has been added. The low calorie sugar substitute compositions provided herein can also be added to a liquid ingredient of a formulation and dispersed before adding the dry ingredients of the formulation.

After adding the low calorie sugar substitute compositions provided herein to the ingredients of the baked good system, the next step of the methods is mixing the ingredients together. Mixing is typically carried out under conditions which produce a uniform distribution of solids within a stable aqueous dispersion and which is capable of providing a uniform distribution of the low calorie sugar substitute compositions provided herein in the bakery ingredients. Mixing is performed by methods which are conventionally used in the art. Mixing can be accomplished in a one, two or more step operation. For example, some of the ingredients can be mixed, the additional components added and then the components are mixed again. The mixing can be performed by hand or with a mixing apparatus such as a hand-held mixer or a free-standing mixer. Alternatively, the dry ingredients are combined in a batch-type mixer and the resulting mix is passed through a mixing unit which will produce a uniform aqueous dispersion, such as a homogenizer or a continuous mixer. The mixing speed and time may vary depending on the type of bakery product being produced, and they can be easily ascertained by the skilled artisan.

The dough or batters are generally prepared at a temperature of less than about or at 115° F. and at or above 50° F. Exemplary dough or batter temperatures can range from about or at 60° F. to about or at 77° F. Before proceeding to the next step of the method, the dough or batter optionally can be permitted to rest without mixing for about or at 20 minutes to about or at 120 minutes to hydrate and achieve optimum consistency.

For certain baked goods, such as cookies, the dough or batter is next shaped or formed into pieces using conventional shaping equipment, e.g., cookie dough forming equipment. For instance, the doughs can be sheeted between counter rotating rollers and cut using rotary or reciprocating cutters. They can be formed into pieces by wire cutting, rotary-molding, enrobing, encrusting or by hand. They can be formed into shape by conventional means, such as a calendar press, an extruder or continuous mixer.

If filler is to be included in the product, the filled products can be produced by co-extruding the dough, batter or dough-like mixture with filler materials. The co-extrudate can be formed by any method known to those skilled in the art, such as by the use of a concentric die or a tube inserted within the die orifice. Filled products can also be produced by transporting the dough-like mixture to a conventional enrobing or encrusting machine.

Examples of fillers that can be used include chocolate-, vanilla-, butterscotch-, fruit-, peanut butter-, and cheese-flavored fillings. The filling material can also be a separately produced dough or batter for the production of multi-flavored, multi-colored or multi-textured baked good product, e.g., cookie. Fillers can be low fat or fat-free, full sugar, low sugar or no sugar. The fillers can be uncooked or cooked prior to co-extrusion with the doughs.

The cutting of dough ropes or extrudates before or after baking can be performed by a guillotine-cutter, a band cutter or a fluid jet cutter.

This shaping of the dough or batter, if necessary, is usually performed prior to baking and subsequent to the mixing step.

The mixed ingredients including the low calorie sugar substitute composition provided herein can optionally be placed in a suitable vessel that is capable of producing the bakery product. It is also possible to refrigerate the mixed bakery dough or batter that includes the low calorie sugar substitute composition provided herein prior to baking. This is sometimes required with yeast-containing bakery systems.

If cookies are the bakery product, the mixed bakery system containing the low calorie sugar substitute composition provided herein is divided into appropriate pieces using, for example, a spoon, and then placed on a cookie sheet. When pies, cakes, breads, doughnuts and muffins are the bakery product, appropriate sized pans or dies for cutting the dough or batter into the appropriate shapes are used.

The next step of the present method involves exposing the mixed bakery system containing the low calorie sugar substitute composition provided herein to heat for a sufficient time to effect an adequate degree of cooking (baking) of the mix. This step of the present method that is a baking step can be carried out in an oven or other heat delivering device, such as a bread making machine, that is capable of heating the bakery system containing the low calorie sugar substitute composition provided herein with dry or moist heat. The exact temperature and time used to bake the various bakery good product mixes containing the low calorie sugar substitute composition provided herein varies for different dough formulations, oven types, etc. and can be determined empirically by one skilled in the art. The mix is exposed to cooking conditions for the appropriate time and temperature to achieve a complete bake.

For example, batter systems used in making cookies can be heated in an oven that exposes the batter to a temperature of from about or at 300° F. to or at 450° F. for a time period of from about or at 9 minutes to about or at 20 minutes. When the comestible is from a bread-type, sweet dough or batter system, including cakes or cheesecakes, the heating step can be carried out in an oven at a temperature of from about or at 300° F. to about or at 450° F. for a time period of from about or at 15 minutes to about or at 90 minutes, or until a complete bake is achieved. For example, in a cake system, a complete bake can be determined empirically, such as by inserting a probe into the baked cake and after removing the probe determining if any unbaked batter has adhered to the probe. Unbaked batter on the probe is indicative of an incomplete bake.

After baking, the finished bakery product is allowed to cool before packaging and/or consumption.

The toppings and cremes systems are generally prepared in the following way. The ingredients of the toppings and cremes, e.g., the low calorie sugar substitute composition provided herein, fat (e.g., butter or shortening) and any additional ingredients described hereinabove, such as flavors or preservatives, are mixed together. As before, the low calorie sugar substitute composition provided herein can be added to a dry mix or it can be added to a mix which additionally contains water. The ingredients are mixed as described hereinabove and then baked, as before. The mixture is then permitted to stand for sufficient amount of time to set.

In the case of coatings, glazes or icings, the mix is placed on top of the dough or batter and then baked. In the case of filler material, it is coextruded with the dough, batter or dough-like mixture, as described hereinabove and then baked, as described hereinabove.

The baked good product produced in accordance herewith can be shelf-stable, refrigerated or frozen.

The addition of the low calorie sugar substitute composition provided herein provides several advantages to the baked goods. In one embodiment of the present methods, the baked good product containing the low calorie sugar substitute composition provided herein retards moisture migration and retains moisture longer than conventional baked goods. Most baked goods tend to lose moisture to the air, dry out and become hard and tough too quickly. The baked goods prepared in accordance with the present methods do not suffer from this problem. The baked goods of the present methods containing the low calorie sugar substitute composition provided herein are more moist. They have an increased ability to retain moisture longer. Thus, another embodiment is directed to a process for retarding moisture migration in a baked good that includes adding the low calorie sugar substitute composition provided herein in a moisture loss retarding effective amount to the unbaked ingredients of the baked goods product, mixing the ingredients under conditions effective to substantially uniformly distribute the low calorie sugar substitute composition provided herein therethrough and baking the mix under conditions sufficient to form the product.

Increased moisture retention gives improved anti-staling properties to the baked goods. Thus, another embodiment is directed to a method for extending the shelf life of a baked good product, which includes adding an anti-staling effective amount of the low calorie sugar substitute composition provided herein to the unbaked ingredients of the baked good product and then repeating the steps described hereinabove.

Moreover, the baked good products containing the low calorie sugar substitute composition provided herein have additional advantages. For example, the addition of the low calorie sugar substitute composition provided herein to the baked goods enhances flavor. For example, panelists were asked to taste the baked good products containing the low calorie sugar substitute composition provided herein and compare it to the taste of the same baked good products in which the low calorie sugar substitute composition provided herein was not used as an ingredient. The baked good products containing the low calorie sugar substitute composition provided herein were judged better tasting, and to have a more intense flavor. Moreover, baked goods containing the low calorie sugar substitute composition provided herein were judged to have a smoother mouthfeel and softness relative to baked good products which do not contain the low calorie sugar substitute composition provided herein.

Thus, another embodiment of the present method is directed to a method of enhancing the flavor of a baked good product, which includes adding a flavor enhancing effective amount of the low calorie sugar substitute composition provided herein to the uncooked ingredients of the baked good product and then mixing and baking as described hereinabove.

In addition, the use of the low calorie sugar substitute composition provided herein in the baked goods results in the baked good products exhibiting improved qualities, e.g., softer texture, enhanced taste and smoother mouthfeel, relative to traditional baked goods containing sugar as the sweetener. Thus, another embodiment of the present methods is directed to a method for enhancing the organoleptic properties of baked goods, which includes admixing an organoleptic improving effective amount of the low calorie sugar substitute composition provided herein to the ingredients of the unbaked goods, then mixing the ingredients and baking as hereinabove.

In each of the embodiments described hereinabove, the effective amounts of the low calorie sugar substitute composition provided herein are within the ranges given hereinabove. For example, an effective amount of the low calorie sugar substitute composition is from about 2 parts to about 60 parts by weight of the total formulation.

4. Frozen Desserts and Frozen Novelties

Frozen dessert is a term of art that has been applied to a wide variety of products including ice cream, frozen yogurt, frozen custard, ice milk, sherbet, frozen novelties, frozen dairy confections and non-dairy frozen confections such as water ices and frozen fruit bars. Fat and sugar are the two primary sources of calories in frozen desserts. While fat contributes most of the calories in typical premium ice creams, sugar also contributes a substantial portion of the calories. Further, some frozen desserts, such as water ices include little if any fat in their formulations. Thus, reduction of sugar in frozen desserts is an effective way to reduce the calorie content of such desserts. Further, sugar has been linked to a variety of health problems including hypertension, coronary heart disease, arterial sclerosis and dental caries. Sugar or sucrose also increases blood glucose and insulin levels and therefore can be hazardous to people suffering from diabetes. Therefore, the reduction of sugar in one's diet may have health benefits beyond the reduction of calories and weight control.

Typical ice creams and frozen desserts are sweetened with sucrose or a combination of sucrose and corn syrup solids. The combination of sucrose and corn syrup solids is generally considered to be the optimum sweetener with regard to taste profile and important properties such as texture, hardness, melting rate and overrun.

Low-calorie frozen confections are known in the art. A mere replacement of sugar by a high intensity sweetener results in a deleterious effect on the structure of the frozen confection, causing the mouthfeel to be inferior and an inferior product to result. Although the high intensity sweeteners can be blended to minimize any unpleasant aftertaste of flavor profile, they usually fail to contribute the body and bulk to the frozen dessert contributed by the sucrose and corn syrup solids. Bulking agents are often used to replace the volume and texture supplied by the sucrose and corn syrup solids and contribute fewer calories than sucrose and corn syrup solids. Bulking agents that can be used in frozen desserts include polyols, polydextrose and maltodextrin. All of these alternative bulking agents, either alone or in combination, fail to provide the texture, taste and other qualities demanded by today's consumers. Specifically, such products are generally inferior in certain essential properties, such as taste, texture, hardness, melting rate and overrun.

For example, a product that replaces the sucrose and corn syrup solids with a blend of maltodextrin, sorbitol and aspartame does not have the same texture, hardness, melting rate or overrun as its traditional counterpart. For example, such products generally are harder when frozen than traditional products, and are often more difficult to mix. Products that are difficult to mix have a lower batch freezer overrun, resulting in a product with less air (and therefore higher manufacturing cost). The product with a blend of sorbitol, maltodextrin and aspartame also melted faster than conventional ice creams.

The low calorie sugar substitute compositions and methods provided herein provide a reduced calorie frozen dessert that can have between 0 and 15% fat content. The caloric content of frozen desserts is reduced by replacing at least a portion of the traditional caloric sweeteners, such as sucrose and corn syrup solids, with the low calorie sugar substitute composition provided herein while maintaining taste profile, texture, hardness, melting rate and overrun.

a. Method of Manufacture

(1) Typical Commercial Manufacture

Frozen desserts can be made by any commercial manufacturing method known to one skilled in the art. Ice Cream by Arbuckle (2nd edition, 1972 Avi Publishing Co., Westport, Conn., USA) or its various editions defines terminology in relation to the ice cream and related frozen novelty business as well as disclosing compositions, methods of molding, handling procedures, freezing procedures, storage procedures, etc. For example, in a typical commercial ice cream operation, a mixture of cream, milk, sugar, added water (optional), added nonfat milk solids (optional), emulsifiers (optional), and stabilizers (optional) is formed, pasteurized and then passed through either a single, or double-stage, homogenizer. During homogenization, the globules of milkfat that are present in the cream and milk are broken up and dispersed as relatively small fat droplets or particles in a continuous aqueous phase, i.e. an oil-in-water emulsion is formed. During the freezing step, the homogenized mixture is typically subjected to agitation, whipping and aeration to incorporate a selected amount of air (referred to as overrun), and to avoid the formation of large ice crystals in, and/or a stratification of, the product. Flavoring substances (e.g., vanilla) and optional inclusions are typically added to this homogenized mixture before it is fully hardened to provide a firm ice cream product. Because of the relatively small particle size of the dispersed milkfat due to homogenization, as well as the small particle size of the dispersed ice crystals and air cells formed during freezing, conventional firm ice cream products provide a relatively smooth, creamy mouthfeel.

(2). Commercial Manufacturing Method using the Low Calorie Sugar Substitute Compositions Provided Herein

The sugar substitute composition provided herein can be mixed with the cream, milk, any added water (optional), added nonfat milk solids (optional), emulsifiers (optional), and stabilizers (optional) until well mixed and the mixture is smooth. The components of the mixture can be combined or added together in any appropriate fashion, and in any order of addition. The fluid mixture is then heated and optionally pasteurized.

Pasteurization can be carried out according to any suitable method that is used in pasteurizing conventional frozen dessert products such as ice cream. See Arbuckle, Ice Cream, (2^{nd} edition, 1972 Avi Publishing Co.) at pages 211-215, which describes the pasteurization of conventional ice cream products. For example, pasteurization can be carried out by batch methods (e.g., at a temperature of at least about or at 155° F., for at least about or at 30 minutes), high temperature short-time methods (e.g., at a temperature of at least about or at 175° F. for at least about or at 25 seconds), vacreation methods (e.g., at a temperature of at least about or at 194° F. for from about or at 1 second to about or at 3 seconds), and ultrahigh temperature methods (e.g., at a temperature of from about or at 210° to about or at 265° F. for from about or at 2 seconds to about or at 40 seconds). The particular pasteurization method and temperature conditions used can alter the flavor characteristics of the mixture, e.g., can impart cooked flavors. Accordingly, the pasteurization method and temperature conditions can be selected with such potential flavor effects in mind.

This heated, fluid mixture is then subjected to a homogenization step. Homogenization is usually accomplished by forcing this fluid mixture through the small orifice of a homogenizer (or orifices in the case of a two-stage homogenizer), using a positive displacement plunger pump to furnish the appropriate pressure. This orifice includes a valve and seat in which the two adjacent surfaces are parallel and lap smooth and is surrounded by an impact ring against which the fluid mixture of ingredients impinges as it leaves the valve. The breakup and size reduction of the fat droplets is caused by the shear forces that occur as a thin stream of the fluid mixture travels at a high velocity between the closely adjacent surfaces of the valve and the seat, and then by the shattering effect that occurs as the thin stream impinges on the impact ring upon leaving the valve. Size reduction of the fat droplets is also caused by cavitation effects. Cavitation is caused by the sudden release of pressure as the thin stream leaves the valve, which momentarily lowers the vapor pressure of the fluid mixture to a point where vapor pockets are formed. The fat droplets bounce back and forth inside these vapor bubbles and are shattered by impacts against the bubble walls, thus causing further size reduction.

The homogenization of this fluid mixture can be carried out by passing the heated fluid mixture through either a one-stage or a two-stage homogenizer. See Arbuckle, Ice Cream, (1977 Avi Publishing Co.), pp. 216-218, for suitable one-stage and two-stage homogenizers, including those manufactured and sold by Gaulin and Cherry-Burrell Corp. In the case of one-stage homogenizers, suitable operating pressures (measured in pounds per square inch or psi) can be in the range of from about or at 800 to about or at 3000 psi, usually from about or at 1500 to about or at 2000 psi. In the case of two-stage homogenizers, the first stage can be operated at a pressure of from about or at 800 psi to about or at 3000 psi, or from about or at 1500 psi to about or at 2000 psi, while the second stage is operated at a pressure of from about or at 500 psi to about or at 1000 psi.

The particular order of the pasteurization and homogenization steps is not critical in preparing the frozen dessert products of the present method. For example, the fluid mixture can be homogenized, and then pasteurized, or can be pasteurized and then homogenized.

The homogenized pasteurized mixture is typically rapidly cooled to a temperature of about or at 40° F. or less, and typically to a temperature in the range of from about or at 32° to about or at 40° F. The cooled mixture is then typically held in this temperature range for a period of from about or at 1 hour to about or at 12 hours, or for from about or at 1 hour to about or at 2 hours, to age the mixture. Aging typically causes the following effects to occur in the mixture: (1) solidification of the fat; (2) slight changes in the protein present; and (3) increases in the viscosity of the mixture. Aging of the mixture is particularly desirable in terms of improving the textural properties and resistance to melting of the resulting frozen dessert product, as well as ease in incorporating air during subsequent freezing. See Arbuckle, Ice Cream, (2^{nd} edition, 1972 Avi Publishing Co.), at page 222.

This homogenized pasteurized mixture optionally can be packaged at this point as a liquid ice cream mix or base, for example for use by restaurants, food suppliers or for consumer use in home freezers.

Alternatively, the homogenized pasteurized mixture, with or without aging, can be subjected to a freezing step to partially freeze or solidify the mixture. The partial freezing of this homogenized pasteurized mixture can be carried out by any standard freezing method used in the preparation of conventional frozen dessert products such as ice cream. See Arbuckle, Ice Cream, (2^{nd} edition, 1972 Avi Publishing Co.), pages 239-266. For example, the homogenized pasteurized mixture can be partially frozen or solidified by using a batch freezer, continuous freezer, low temperature continuous freezer, a soft serve-type freezer, or a counter-type freezer. The particular temperature and time conditions for carrying out this partial freezing step can vary greatly depending upon the type of freezer used, and can be determined empirically.

For example, the homogenized pasteurized mixtures of the present method can be partially frozen at temperatures in the range of from about or at 15° F. to about or at 28° F. over a period of from about or at 20 seconds (e.g., continuous or low temperature continuous freezer) to about or at 10 minutes (e.g., batch or counter freezer). During partial freezing, it is often desirable to agitate, aerate and/or whip the mixture to incorporate air to provide a selected amount of overrun. The particular amount of overrun obtained can be any level appropriate for conventional frozen dessert products, in particular ice cream products, and can be determined empirically by one skilled in the art.

For example, a mixture of ingredients can be formed by adding fluid milk, cream, the low calorie sugar substitute provided herein, water, non-fat dry milk solids and egg yolks to a mix tank in the order indicated or in any order or combination. The contents of the mix tank can be mixed together and heated to a temperature of from 145° to 150° F., and then can be passed through a two-stage homogenizer operated at a pressure of 1500 psi in the first stage and 500 psi in the second stage. This homogenized mixture then can be pasteurized at 175° F. for three minutes. This homogenized pasteurized mixture then can be cooled to a temperature of approximately 40° F., and optionally then can be aged at this cooler temperature for 1 to 2 hours. Flavor, such as vanilla, and optionally coloring then can be added.

The flavored and optionally colored mixture then can be frozen while incorporating air to 100% overrun at about or at 22° F. for 25-40 seconds in a continuous freezer to provide an aerated semi-solid, pumpable mixture which is filled into containers and then fully hardened at −40° F. for 10-24 hours to provide a firm product.

The low calorie sugar substitute provided herein can be used to provide frozen desserts such as ice cream bars, novelty dessert bars, yogurt bars, ice milk bars, and fudge pops that possess the organoleptic characteristics of products made with traditional sugar or corn sweeteners. The low calorie sugar substitute provided herein can be used to provide quiescently frozen desserts.

The mix can also be used to make soft serve ice creams or soft serve ice milks. Soft serve products usually are frozen in a special soft serve freezer, are dispensed by extrusion at carefully chosen subfreezing temperatures and they stand up in a cone or dish upon extrusion. Conventional soft serve products are usually dispensed at an overrun on the order of 40% to 60%. Soft serve products of this character have been known for many years and are available primarily from stores having special freezers that dispense the product for immediate consumption. The soft serve products are usually dispensed at temperatures between 16° F. and 24° F. At lower temperatures, the product is generally no longer soft. There is considerable published art on the subject of soft frozen desserts, particularly ice cream. A pertinent text is Ice Cream, Second Edition by W. S. Arbuckle (1972, Avi Publishing Company, Inc., Westport, Conn., pp. 278-291).

(3). Home Manufacturing Method using the Low Calorie Sugar Substitute Compositions Provided Herein

The low calorie sugar substitute compositions provided herein can be used to make frozen desserts in a non-commercial setting, such as by consumers at home, using a home ice cream freezer. Numerous home ice cream freezers are known to those skilled in the art (for example, see U.S. Pat. No. 4, 741,174 to Martin et al.). The packaged ice cream mix as described above can be used by the consumer in a home ice cream freezer to prepare the a low sugar or sugar added ice cream.

The consumer can also make ice cream, sherbet and other frozen desserts using the low calorie sugar substitute composition provided herein as an ingredient in an existing formulation, replacing a portion or all of the traditional sweeteners with the low calorie sugar substitute composition provided herein, where the amount of low calorie sugar substitute composition provided herein used to replace the sugar is between about or at 40% to about or at 60% of the amount of sugar replaced in the formulation. In one embodiment, the amount of the low calorie sugar substitute composition provided herein used in the formulation is 40%, 42%, 44%, 46%, 48%, 50%, 52%, 54%, 56%, 58% or 60% of the amount of sugar replaced. For example, in a full fat vanilla ice cream formulation that includes 6 cups of heavy cream, 4.5 cups of whole milk, 1 cup of sugar, 6 eggs, and 2 tablespoons of vanilla extract, at least a portion of the 1 cup of sugar can be replaced with the low calorie sugar substitute composition provided herein. For a no sugar added formulation, all of the sugar is replaced with the low calorie sugar substitute composition provided herein, for example, replacing the 1 cup of sugar with from about or at 0.4 cup to about or at 0.6 cup of the low calorie sugar substitute composition provided herein.

For example, to make a no sugar added ice cream, the ingredients listed above are mixed together in any order. For example, the sugar substitute composition, eggs and vanilla are mixed together until smooth, and the heavy cream and milk are added and mixed thoroughly. The mixture is placed into a home ice cream freezer and frozen, following the ice cream freezer manufacturer's directions.

b. Water Ices

Water ices are a category of frozen desserts, and are known to those skilled in the art (for example, see U.S. Pat. No. 4,724,153 to Dulin et al.). The water ices generally are composed of water, sugar and/or corn sweeteners, flavors, and optionally fruit purees and colorants. These frozen desserts often present special problems when reformulating to remove caloric sweeteners because the sweetener can be the highest contributor of total solids in the final product. In previous attempts to reduce the caloric content of frozen desserts, only part of the sugar was replaced by sweeteners such as aspartame. This was necessary because the amount of aspartame required to replace a given volume of sugar and keep the same sweetness level is very small as aspartame is about 200 times as sweet as sugar. This results in a reduction in volume which has a deleterious effect on the structure of the dessert, causing the mouthfeel to be inferior and an inferior product to result.

Traditional formulations sweetened with sugar and/or corn sweeteners generally include 5-30% sweeteners and can include additional ingredients, such as 0.1-0.5% stabilizer, 0.2% citric acid, 0.1% emulsifier, flavor, preservative and colorant. In low solids systems, such as frozen ices and frozen fruit bars, and especially low solid systems that do not include fat, it has been found that addition of a soluble fiber as a bulking agent in addition to the low calorie sugar substitute composition provided herein to replace the total solids contributed by the traditional sugar or corn sweeteners results in a product with organoleptic properties similar to the traditional product. For example, in one embodiment, the caloric sweetener in a low solids low-fat or non-fat formulation is replaced with a combination that includes an amount of the low calorie sugar substitute composition provided herein from about or at 40% to about or at 60% of that of the caloric sweetener and an amount of soluble fiber from about or at 2% to about or at 60% of that of the caloric sweetener or any combination thereof in between. In one embodiment, the amount of the low calorie sugar substitute composition provided herein used in the formulation is 40%, 42%, 44%, 46%,48%, 50%, 52%, 54%, 56%, 58%, or 60% of the amount of sugar replaced. In another embodiment, the amount of soluble fiber included in the formulation is 2%, 4%, 6%, 8%, 10%, 12%, 14%, 16%, 18%, 20%, 22%, 24%, 26%, 28%, 30%, 32%, 34%, 36%, 38%, 40%, 42%, 44%, 46%, 48%, 50%, 52%, 54%, 56%, 58% or 60% of the amount of sugar replaced.

In another embodiment, the frozen dessert product includes an amount of one or a blend of two or more low viscosity soluble fibers of from about or at 0.5 part to about or at 50 parts by weight of the frozen dessert product. In another embodiment, the frozen dessert product includes 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48,49 or 50 parts by weight of the frozen dessert product of one or a blend of two or more low viscosity soluble fibers.

By way of example, in a batch formulation that uses 10 pounds of sugar, all of the sugar can be replaced with about or at 6 pounds of the low calorie sugar substitute composition provided herein and about or at 4 pounds of a low viscosity soluble fiber, or the sugar can be replaced with about or at 4 pounds of the low calorie sugar substitute composition provided herein and about or at 6 pounds of a low viscosity soluble fiber. It has been found that the soluble fiber helps to control the growth and size of ice crystal formation during freezing, and contributes to the organoleptic properties of the frozen low solids systems, especially mouthfeel. In systems that include fat, the amount of soluble fiber can be reduced, because the fat in the system helps to control ice crystal formation and texture development. Thus, in low solids systems, replacing the traditional caloric sweeteners with a combination of a low calorie sugar substitute composition provided herein and a low viscosity soluble fiber results in a product similar in structure and organoleptic properties as achieved with the caloric sweeteners.

Any low viscosity soluble fiber known to one skilled in the art can be used. Low viscosity soluble fibers include, but are not limited to, digestion resistant or indigestible maltodextrin, such as Fibersol® 2, hydrolyzed guar gum, low viscosity pectin, low viscosity curdlan, low viscosity propylene glycol alginate, low viscosity cellulose derivatives including carboxymethyl cellulose and hydroxypropyl methylcellulose, enzymatically depolymerized naturally-occurring polysaccharides, such as those described in U.S. Pat. No. 6,299,924 to Chiu et al. (which include depolymerized pectin, tamarind seed gum, guar gum, locust bean (carob seed) gum, konjac gum, xanthan gum, alginates, agar and other food gums), alteman, gum arabic and modified starches, such as enzyme-resistant starch.

a. Method of Manufacture

(1). Dynamic Freezing and Aeration

Dynamic freezing and aeration usually results in smaller ice crystal size and a smoother, non-icy texture. Thus, many frozen water ice desserts are processed similarly to that of ice cream. For example, water and most of the dry ingredients are mixed together and pasteurized at suitable time and temperature conditions. The aqueous mix is then cooled and combined with additional ingredients such as heat-sensitive flavors, fruit purees etc., and passed to a continuous ice cream freezer where the mix is partially frozen and aerated. The freezer produces an ice slurry having an overrun of from 5 to 100% or more, such as 125% and up to 150%, and every integral in between, such as 10%,20%, 30%, 40%, 55%, 60%, 70%, 80%, 90% and so forth. The slurry temperature in the freezer is usually between about or at 5° F. to about or at 25° F., and in one embodiment is between about or at 10° F. to about or at 20° F. The partially frozen slurry then can be packaged and hardened at about or at −20° F. to about of at −40° F.

(2). Non-Aerated Quiescently Frozen Desserts

The frozen water ice desserts also can be quiescently frozen. Quiescently frozen desserts having different colors and flavors and optionally fruit solids have been prepared over the years, such as those sold under the Popsicle® and Fudgesicle® names. Such confections can include milk, and usually include suitable flavoring, fruits, sugars, such as sugar and corn sugars, acid, stabilizers and preservative, such as sodium benzoate and potassium sorbate or sorbic acid. The non-aerated, quiescently-frozen products usually possess a brittle, icy texture exemplified by conventional ice pop products. Some of the non-aerated, quiescently-frozen products, such as the basic ice pops, have a very coarse, icy texture and are often brittle, which leads to large pieces breaking away from the stick when these products are bitten into.

The low calorie sugar substitute provided herein can be used to provide non-aerated, quiescently-frozen dessert products that possess the organoleptic characteristics of products made with traditional sugar or corn sweeteners, and usually have a smaller ice crystal size and therefore an improved mouthfeel.

The examples shown below illustrate the use of the low calorie sugar substitute composition provided herein in the preparation of baked goods and other comestibles. The following examples are included for illustrative purposes only and are not intended to limit the scope of the invention.

### EXAMPLES

EXAMPLE 1
Preparation of the Low Calorie Sugar Substitute

| Ingredient | Weight (lbs) | % |
|---|---|---|
| Sorbitol | 970 | 48.34 |
| Water | 970 | 48.34 |
| Sodium alginate | 8 | 0.4 |
| Calcium sulfate | 6 | 0.3 |
| Dihydrate | | |
| Guar gum | 20 | 1.0 |
| Wheat plant fiber | 10 | 0.5 |
| Propylene glycol | 20 | 1.0 |
| Neotame | 0.4 | 0.02 |
| Potassium sorbate | 2 | 0.1 |
| TOTAL | 2006.4 | 100.00 |

1. Blend the sorbitol, neotame and potassium sorbate together and add to the water, using continuous agitation.
2. Mix the alginate and the wheat plant fiber in a portion of the propylene glycol to form a slurry; add the slurry to the water phase from step 1 under continuous shear.
3. Mix the guar gum with a portion of the propylene glycol to make a slurry; add the slurry to the water phase from step 2 under continuous shear; allow to mix until uniform throughout.
4. Mix the calcium sulfate with the remainder of the propylene glycol to make a slurry and add to the water phase from step 3 under continuous shear. Allow to mix for approximately 30 minutes and then dispense the mix into containers.
5. Store the mix in containers and allow to stand at room temperature overnight to gel.

EXAMPLE 2
Sugar-Free French Butter Cookie

| | % (flour as 100%) |
|---|---|
| Sugar substitute composition | 25 |
| Butter | 60 |
| Shortening | 20 |
| Salt | 0.265 |
| Eggs | 25 |
| Cake flour | 100 |
| Milk protein | 3.75 |
| Vanilla | 0.625 |

1. Blend the cake flour and milk protein together. Cream the sugar substitute composition with the cake flour and milk protein mixture until smooth. Add the butter and shortening and mix until smooth.
2. Add in the eggs, vanilla and salt and mix until creamed together.
3. Deposit appropriate portions of the cookie dough on ungreased baking sheets and bake at 375° F. until edges begin to turn golden, about 12-15 minutes.

EXAMPLE 3
Sugar-Free Chocolate Chip Cookies

| | % (flour as 100%) |
|---|---|
| Sugar substitute composition | 47.9 |
| Butter | 66 |
| Eggs | 33 |
| Cake flour | 100 |
| Sugar-free Chocolate chips | 100 |
| Vanilla | 2 |
| Baking Soda | 1 |
| Salt | 1 |

1. Dry blend the cake flour, salt and baking powder together.
2. Cream the low calorie sugar substitute composition with the cake flour mixture until smooth.
3. Add the butter and mix until smooth.
4. Add in the eggs and vanilla and mix until creamed together.
5. Deposit appropriate portions of the cookie dough on ungreased baking sheets and bake at 375° F. for about 12-15 minutes.

EXAMPLE 4
Sugar-Free Cheesecake

| | % (cream cheese as 100%) |
|---|---|
| Sugar substitute composition | 25 |
| Butter | 6.66 |
| Cream cheese | 100 |
| Corn starch | 3.33 |
| Vanilla | 0.83 |
| Salt | 0.41 |
| Eggs | 40 |
| Whole milk | 26.66 |

1. Soften the cream cheese and butter by allowing them to come to room temperature.
2. Cream the sugar substitute composition with the corn starch until smooth.
3. Add the butter and mix until smooth.
4. Blend in the cream cheese until smooth and completely mixed.
5. Add in the eggs and vanilla and mix until creamed together.
6. Slowly add the whole milk while mixing until completely incorporated.
7. Deposit the mixture into appropriately prepared spring-form pan and bake in a preheated 375° F. over for 50-60 minutes, or until set.

EXAMPLE 5
Sugar-Free Muffin

| | % (flour as 100%) |
|---|---|
| Sugar substitute composition | 40 |
| Salad oil | 50 |
| Cake flour | 100 |
| Non-fat milk solids | 8 |
| Salt | 1 |
| Baking powder | 3 |
| Clearjel ® modified corn starch | 2 |
| Eggs | 56 |
| Water | 56 |

1. Dry blend the cake flour, non-fat milk solids, salt and baking powder together.
2. Cream the sugar substitute composition with the cake flour mixture until smooth.
3. Add the salad oil and mix until smooth.
4. Add in the eggs, modified corn starch and vanilla and mix until creamed together.
5. Deposit appropriate portions of batter into paper liners or prepared muffin tins and bake at 375° F. for 8-10 minutes.

EXAMPLE 6
“No Sugar Added” Chocolate Chip Ice Cream

| | | % |
|---|---|---|
| Sugar substitute composition | 0.3 cups | 8 |
| Heavy cream | 2.0 cups | 40 |
| Whole milk | 1.5 cups | 32 |
| Eggs | 2 | 4 |
| Vanilla | 2 tsp | 1 |
| Sugar-free chocolate chips | 0.5 cups | 15 |

1. Whip together the sugar substitute composition, eggs and vanilla until smooth.
2. Blend in the heavy cream and milk and pour into ice cream maker and begin to freeze.
3. Once the product has begun to freeze, mix in the sugar-free chocolate chips and mix until smooth and frozen.

EXAMPLE 7
“No Sugar Added” Lightning Cake

| | |
|---|---|
| All-purpose flour | 1 cup |
| Baking powder | 1 teaspoon |
| Salt | ¼ teaspoon |
| Butter, softened | ½ pound |
| Sugar substitute composition | ½ cup |
| Wheat plant fiber | ¼ cup |
| Instant starch | ¼ cup |
| Eggs | 3 |
| Grated lemon zest | 1 teaspoon |
| Fresh lemon juice | 2 teaspoons |

1. Whisk together thoroughly the flour, baking powder and salt.
2. In a separate bowl, beat until creamy on medium to high speed. about 3 to 5 minutes, the butter, low calorie sugar substitute and the insoluble fiber.
3. Beat in the eggs one at a time, allowing each to be thoroughly incorporated before adding the next.
4. Beat in the lemon zest and lemon juice just until mixed.
5. Stir in the flour mixture just until smooth. Scrape the batter into a prepared pan (greased and floured or lined with waxed paper or parchment paper on the bottom) and spread evenly. Bake in a preheated 350° F. oven for about 30 to 35 minutes. Allow the cake cool in the pan for about 15 minutes, then remove from the baking pan and allow the cake to cool on a wire rack.

Since modifications will be apparent to those of skill in this art, it is intended that this invention be limited only by the scope of the appended claims.

What is claimed is:

1. An aqueous gel composition, comprising:
a polyol;
a high intensity sweetener;
an insoluble fiber; and
a gelling agent, wherein the composition is an aqueous gel and is a low calorie sugar substitute.

2. The aqueous gel composition of claim 1, further comprising a thickener.

3. The aqueous gel composition of claim 1, wherein water comprises from about 30 to about 80 parts by weight of the composition.

4. The aqueous gel composition of claim 3, wherein the polyol comprises from about 20 to about 70 parts by weight of the composition.

5. The aqueous gel composition of claim 1, wherein the high intensity sweetener comprises from about 0.001 to about 0.1 parts by weight of the composition.

6. The aqueous gel composition of claim 2, wherein the thickener comprises from about 0.2 to about 2 parts by weight of the composition.

7. The aqueous gel composition of claim 1, wherein the insoluble fiber comprises from about 0.1 to about 10 parts by weight of the composition.

8. The aqueous gel composition of claim 1, comprising:
from about 30 to about 80 parts by weight of water;
from about 20 to about 70 parts by weight of a polyol;
from about 0.001 to about 0.01 parts by weight of a high intensity sweetener;
from about 0.2 to about 2 parts by weight of a thickener;
from about 0.1 to about 10 parts by weight of an insoluble fiber; and
from about 0.2 to about 2 parts by weight of a gelling agent; wherein the composition is a low calorie sugar substitute.

9. The composition of claim 8, wherein the composition is a viscoplastic fluid.

10. The composition of claim 1, wherein the polyol is selected from the group consisting of erythritol, mannitol, lactitol, isomalt, maltitol, xylitol, sorbitol, glucomannitol, glucosorbitol, glycerol, an hydrogenated starch hydrolysate and combinations thereof.

11. The composition of claim 1, wherein the high intensity sweetener is selected from the group consisting of saccharin, cyclamate, aspartame, acesulfame-K, stevioside, alitame, neotame, sucralose, neohesperidine dihydrochalcone, thaumatin, glycyrrhizin, monoammonium glycyrrhizinate, stevioside, maltol, ethyl maltol, chlorodeoxysucrose, dulcin, 5-nitro-2-n-propoxyaniline, suosan, miraculin, monellin, substituted imidazolines, n-substituted sulfamic acids, perilartine, rebaudioside, aspartyl malonates, succanilic acids, gem-diaminoalkanes, meta-amino-benzoic acid, L-amino-dicarboxylic acid alkanes, gem-diamines, 3-hydroxy-4-alkyloxyphenyl aliphatic carboxylates, heterocyclic aromatic carboxylates and combinations thereof.

12. The composition of claim 1, wherein the high intensity sweetener is neotame.

13. The composition of claim 1, wherein the high intensity sweetener is heat stable.

14. The composition of claim 1, wherein the thickener is selected from the group consisting of guar gum, guar derivatives, tara gum, tamarind seed gum, gum arabic, alternan, gum tragacanth, karaya gum, gum ghatti, locust bean gum, inulin, konjac mannan, pectin, dextran, gellan gum, rhamsan gum, welan gum, xanthan gum, tamarind, scleroglucan, propylene glycol alginate, carboxymethyl-cellulose, methyl hydroxypropyl cellulose, hydroxypropyl cellulose, hydroxyethyl cellulose, hydroxypropyl guar, modified starches and combinations thereof.

15. The composition of claim 1, wherein the insoluble fiber is selected from the group consisting of bamboo fiber, soy fiber, corn bran fiber, corn fiber, sugar beet fiber, pea hull fiber, wheat bran fiber, wheat plant fiber, oat bran fiber, rice bran fiber, alpha cellulose, hemicellulose, microcrystalline cellulose, bacterial cellulose, chicory root fiber and combinations thereof.

16. The composition of claim 1, wherein the gelling agent is selected from the group consisting of carrageenan, agar, gellan gum, pectin, gelatin, xanthan gum/locust bean gum, a modified starch, furcelleran, curdlan and alginate.

17. The composition of claim 1, wherein the gelling agent is cold water soluble.

18. The composition of claim 1, wherein the gelling agent forms a heat stable gel.

19. The composition of claim 1, wherein the polyol is sorbitol and the gelling agent is alginate.

20. The composition of claim 1, wherein the composition is pseudoplastic under shear.

21. The composition of claim 1, wherein the composition has a thermal stability in baking and cooking similar to that of sucrose.

22. A method for making a pumpable low calorie sugar substitute composition of claim 1, comprising:
(a) dispensing into a mixing tank a weight of water from about 30 to about 80 parts by weight of the composition;
(b) mixing into the water a polyol and a high intensity sweetener, singly in any order or in combination;
(c) adding to the mixture an insoluble fiber and a gelling agent, singly in any order or in any combination, under mixing conditions that result in a substantially homogeneous blend; and
(d) adding to the mixture a gel initiator that reacts with the gelling agent to form a viscoplastic aqueous gel.

23. A comestible, comprising from about 2 to about 60 parts by weight of the aqueous gel composition of claim 1.

24. The comestible of claim 23, wherein the comestible is selected from the group consisting of baked goods, confections, frozen desserts, granola bars, fruit bars, sauces, salad dressings and sports nutrition beverages.

25. The comestible of claim 24, further comprising from about 1 to about 30 parts by weight of an insoluble fiber.

26. The comestible of claim 25, wherein the insoluble fiber is selected from the group consisting of bamboo fiber, soy hull fiber, soy cotyledon fiber, corn bran fiber, corn fiber, sugar beet fiber, pea hull fiber, wheat bran fiber, wheat plant fiber, oat bran fiber, rice bran fiber, alpha cellulose, hemicellulose (beta & gamma cellulose), microcrystalline cellulose, bacterial cellulose, chicory root fiber and combinations thereof.

27. The comestible of claim 24, wherein the comestible is a frozen dessert product.

28. The comestible of claim 27, further comprising a low viscosity soluble fiber.

29. The comestible of claim 28, wherein the low viscosity soluble fiber comprises from about 0.5 to about 50 parts by weight of the frozen dessert product.

30. The comestible of claim 28, wherein the low viscosity soluble fiber is selected from the group consisting of indigestible maltodextrin, hydrolyzed guar gum, low viscosity pectin, low viscosity curdlan, low viscosity carboxymethyl cellulose, low viscosity hydroxypropyl methylcellulose, depolymerized pectin, depolymerized tamarind seed gum, depolymerized guar gum, depolymerized locust bean (carob seed) gum, depolymerized konjac gum, depolymerized xanthan gum, alternan, gum arabic, enzyme-resistant starch and combinations thereof.

31. A process for retarding moisture migration in a baked good product, comprising:
adding a moisture loss retarding effective amount of the aqueous gel composition of claim 1 to a combination of the unbaked ingredients of the baked good;
mixing the ingredients under conditions effective to substantially uniformly distribute the aqueous gel composition therethrough to make a mix; and
baking the mix under conditions sufficient to form a baked good product.

32. A process for extending the shelf life of a baked good product, comprising:
adding an anti-staling effective amount of the composition of claim 1 to a combination of the unbaked ingredients of the baked good;
mixing the ingredients under conditions effective to substantially uniformly distribute the aqueous gel composition therethrough to make a mix; and
baking the mix under conditions sufficient to form a baked good product.

33. A method of enhancing the flavor of a baked good product, comprising:
adding a flavor enhancing effective amount of the aqueous gel composition of claim 1 to a combination of the unbaked ingredients of the baked good;
mixing the ingredients under conditions effective to substantially uniformly distribute the aqueous gel composition therethrough to make a mix; and
baking the mix under conditions sufficient to form a baked good product.

34. A process for enhancing the organoleptic properties of a baked good product, comprising:
adding an organoleptic improving effective amount of the aqueous gel composition of claim 1 to a combination of the unbaked ingredients of the baked good;
mixing the ingredients under conditions effective to substantially uniformly distribute the aqueous gel composition therethrough to make a mix; and
baking the mix under conditions sufficient to form a baked good product.

35. A method of making a low sugar frozen dessert product, comprising:
selecting a frozen dessert product formulation of ingredients comprising sugar or a corn sweetener;
replacing at least a portion of the sugar or the corn sweetener with the aqueous gel composition of claim 1;
mixing the aqueous gel composition with the other ingredients of the frozen dessert product to form a mix of smooth consistency;
cooling the mix to a cooled temperature;
optionally holding the mix at the cooled temperature for a period of from about 1 to about 100 hours; and
freezing the mix to produce a low sugar frozen dessert product.

36. A method of enhancing the flavor of a frozen dessert product, comprising:
adding a flavor enhancing effective amount of the aqueous gel composition of claim 1 to a combination of ingredients of a frozen dessert product;
mixing the ingredients under conditions effective to substantially uniformly distribute the aqueous gel composition therethrough to make a mix; and
freezing the mix under conditions sufficient to form the frozen dessert product.

37. A method for reducing the caloric content of a comestible, comprising:
selecting a food product formulation that includes a caloric sweetener; and
replacing at least a portion of the caloric sweetener with an amount of the aqueous gel composition of claim 1.

38. An article of manufacture, comprising:
an aqueous gel composition of claim 1;
packaging material; and
a label that indicates that the composition is used for replacing a caloric sweetener in a comestible.

39. An article of manufacture, comprising:
a ready-to-prepare comestible formulation that includes the aqueous gel composition of claim 1;
packaging materials; and
instructions for preparation of the comestible.

40. An article of manufacture, comprising:
a ready-to-eat comestible that includes the aqueous gel composition of claim 1;
packaging materials; and
a label.

41. A kit, comprising:
an aqueous gel composition of claim 1; and
instructions for using the composition to replace a caloric sweetener in a comestible.

42. A kit, comprising:
a first container comprising an aqueous gel composition of claim 1;
a second container comprising a blend of two or more ingredients of a comestible formulation; and
instructions for preparing the comestible.

43. The kit of claim 42, wherein the comestible is selected from among cakes, crackers, cookies, brownies, muffins, rolls, bagels, strudels, pastries, croissants, biscuits, bread, pizza, buns, ice cream, frozen yogurt, frozen custard, ice milk, sherbet, frozen novelties, frozen dairy confections, frozen non-dairy frozen confections, water ices, frozen fruit bars, processed flavored dairy drinks, egg nog, breakfast bars, custards, puddings, salad dressings, sauces, icings, confections, confection toppings, syrups, pie fillings, sports drinks, nutrition bars, nutrition gels, probiotic yogurt and cultured dairy foods.
